(19) United States
(12) Patent Application Publication
(10) Pub. No.: US 2026/0211392 A1
(43) Pub. Date: Jul. 23, 2026

(54) MAINTENANCE AND OPERATION SYSTEM AND MAINTENANCE AND OPERATION METHOD

(71) Applicant: NEC Corporation, Tokyo (JP)

(72) Inventors: Mitsuru MORIKAWA, Tokyo (JP); Youichi SUGIHARA, Tokyo (JP); Takahiro HASEGAWA, Tokyo (JP)

(73) Assignee: NEC Corporation, Tokyo (JP)

(21) Appl. No.: 19/432,350

(22) Filed: Dec. 24, 2025

(30) Foreign Application Priority Data
Jan. 17, 2025 (JP) 2025-006556
Sep. 16, 2025 (JP) 2025-153408

(51) Int. Cl. G05B 19/042; G06F 13/38; G06F 16/955

(52) U.S. Cl. CPC G05B 19/0426; G06F 13/382; G06F 16/9554; G05B 2219/23363

(57) ABSTRACT

A maintenance and operation system of the present disclosure includes a generation device configured to receive an input of work information including a type of maintenance and operation work and a work parameter necessary for the maintenance and operation work, and generate a control instruction including commands to be input to a control target network device and information regarding an input order of the commands based on the work information, a storage device configured to store the control instruction, and an input device configured to input the commands to the control target network device in the input order of the commands based on the control instruction.

### INCORPORATION BY REFERENCE

This application is based upon and claims the benefit of priority from Japanese patent application No. 2025-006556, filed on January 17, 2025 and Japanese patent application No. 2025-153408, filed on September 16, 2025, the disclosure of which is incorporated herein in its entirety by reference.

### TECHNICAL FIELD

The present disclosure relates to a maintenance and operation system and a maintenance and operation method.

### BACKGROUND ART

A network (hereinafter appropriately referred to as “NW”) such as the Internet is achieved by connecting various NW devices forming the NW to each other, and the NW devices are maintained and operated daily by a communication carrier.

For example, maintenance and operation of NW devices forming an NW (hereinafter referred to as a “service NW”) that provides a service in which user data flows are remotely performed via a data communication network (DCN) that is an NW different from the service NW. The DCN is a dedicated NW for the maintenance and operation of the NW device and is disclosed in, for example, Non Patent Literature 1 below.

Non Patent Literature 1: Telecommunication Technology Committee (TTC) standard JT-M3010, “Principles for a Telecommunications Management Network <Overview of a Telecommunications Management Network >”, [online], established on November 27, 2001, The Telecommunication Technology Committee, [searched on January 6, 2025], Internet <URL:https://www.ttc.or.jp/application/files/7115/5427/6672/JT-M3010v2.pdf>.

Here, a related art for performing maintenance and operation work on an NW device via a DCN will be described.

FIG. 1 is a diagram illustrating an image example of maintenance and operation work for an NW device in the related art. In FIG. 1, it is assumed that maintenance and operation work for adding a new NW device 81T is performed on a service NW 82 including a plurality of NW devices 81. In FIG. 1, it is assumed that the plurality of NW devices 81 forming the service NW 82 are connected to a DCN 83, and a control monitoring system 84 is connected to the DCN 83.

As illustrated in FIG. 1, in the related art, a worker bringing a personal computer (PC) enters an office building where a new NW device 81T is first installed, and connects the brought PC to a management port (a temporary connection port for maintenance work) 810 of the NW device 81T. Next, the worker performs setting (S101) for connecting the NW device 81T to the DCN 83. Accordingly, the NW device 81T can be remotely controlled from the control monitoring system 84 at an operation center. Next, the setting (S102) for incorporating the NW device 81T into the service NW 82 is remotely performed from the control monitoring system 84.

### SUMMARY

However, in the related art illustrated in FIG. 1, the NW device is required to be connected to a DCN in order to perform maintenance and operation work on the NW device. Therefore, there is a problem that a work location where the maintenance and operation work is performed is limited to a location connectable to the DCN. Therefore, there is an increasing demand for a technique capable of performing the maintenance and operation work on the NW device without connecting the NW device to the DCN.

Accordingly, in view of the above-described problem, an example object of the present disclosure is to provide a maintenance and operation system and a maintenance and operation method capable of performing maintenance and operation work on a network device without connecting the network device to a DCN.

According to one example aspect, a maintenance and operation system includes

a generation device configured to receive an input of work information including a type of maintenance and operation work and a work parameter necessary for the maintenance and operation work, and generate a control instruction including commands to be input to a control target network device and information regarding an input order of the commands based on the work information,

a storage device configured to store the control instruction, and

an input device configured to input the commands to the control target network device in the input order of the commands based on the control instruction.

According to another example aspect, a maintenance and operation method is

a method executed by a maintenance and operation system and includes

receiving an input of work information including a type of maintenance and operation work and a work parameter necessary for the maintenance and operation work,

generating a control instruction including commands to be input to a control target network device and information regarding an input order of the commands based on the work information,

storing the control instruction in a storage device, and

inputting the commands to the control target network device in the input order of the commands based on the control instruction.

According to the above aspects, it is possible to provide a maintenance and operation system and a maintenance and operation method capable of performing maintenance and operation work on a network device without connecting the network device to a DCN.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a diagram illustrating an image example of maintenance and operation work for an NW device in a related art;

FIG. 2 is a diagram illustrating an image example of maintenance and operation work for an NW device according to the present disclosure;

FIG. 3 is a diagram illustrating an operation example of a preliminary preparation phase according to the present disclosure;

FIG. 4 is a diagram illustrating an operation example of an automated execution phase according to the present disclosure;

FIG. 5 is a diagram illustrating a configuration example of a maintenance and operation system according to the present disclosure;

FIG. 6 is a diagram illustrating an example of items of work information input to a command generator according to the present disclosure;

FIG. 7 is a diagram illustrating an example of a work implementation procedure manual according to the present disclosure;

FIG. 8 is a diagram illustrating an example of a method of connecting a smart device and a control adapter according to the present disclosure;

FIG. 9 is a diagram illustrating an operation example of the command generator according to the present disclosure;

FIG. 10 is a diagram illustrating an example of screen transition of a smart device according to the present disclosure;

FIG. 11 is a diagram illustrating an operation example of an automated execution phase by the smart device, a server, and the control adapter according to the present disclosure;

FIG. 12 is a diagram illustrating an image example of maintenance and operation work for the NW device according to the present disclosure;

FIG. 13 is a diagram illustrating an operation example of a preliminary preparation phase according to the present disclosure;

FIG. 14 is a diagram illustrating an operation example of an automated execution phase according to the present disclosure;

FIG. 15 is a diagram illustrating a configuration example of a maintenance and operation system according to the present disclosure;

FIG. 16 is a diagram illustrating an example of a method of connecting a smart device and a control adapter according to the present disclosure;

FIG. 17 is a diagram illustrating an image example of maintenance and operation work for the NW device according to the present disclosure;

FIG. 18 is a diagram illustrating an operation example of an automated execution phase according to the present disclosure;

FIG. 19 is a diagram illustrating a configuration example of a maintenance and operation system according to the present disclosure;

FIG. 20 is a diagram illustrating an example of a method of connecting a smart device and a control adapter according to the present disclosure;

FIG. 21 is a diagram illustrating an image example of maintenance and operation work for the NW device according to the present disclosure;

FIG. 22 is a diagram illustrating an operation example of a preliminary preparation phase according to the present disclosure;

FIG. 23 is a diagram illustrating an operation example of an automated execution phase according to the present disclosure;

FIG. 24 is a diagram illustrating a configuration example of a maintenance and operation system according to the present disclosure;

FIG. 25 is a diagram illustrating an example of a work implementation procedure manual according to the present disclosure;

FIG. 26 is a diagram illustrating an example of a method of connecting a smart device according to the present disclosure;

FIG. 27 is a diagram illustrating an operation example of the command generator according to the present disclosure;

FIG. 28 is a diagram illustrating an operation example in a case where backup work is performed on the NW device according to the present disclosure;

FIG. 29 is a diagram illustrating an operation example in a case where restoration work is performed on the NW device according to the present disclosure;

FIG. 30 is a diagram illustrating an operation example in a case where data collection work is performed on the NW device according to the present disclosure;

FIG. 31 is a diagram illustrating an operation example in a case where data collection work is performed on the NW device according to the present disclosure;

FIG. 32 is a diagram illustrating an operation example in a case where data uploading work is performed on the NW device according to the present disclosure;

FIG. 33 is a diagram illustrating a configuration example of a maintenance and operation system according to the present disclosure; and

FIG. 34 is a block diagram illustrating a hardware configuration example of a computer that implements some or all of functions of constituent elements included in the maintenance and operation system according to the present disclosure.

### DETAILED DESCRIPTION

### EXAMPLE EMBODIMENT

Hereinafter, example embodiments of the present disclosure are described below with reference to the drawings. The following description and drawings are omitted and simplified as appropriate to clarify description. In the following drawings, the same elements are denoted by the same reference numerals, and redundant description will be omitted as necessary. Specific numerical values and the like shown below are merely examples for facilitating understanding of the present disclosure, and are not limited thereto.

### First Example Embodiment

### Image of First Example Embodiment

First, an image of a first example embodiment will be described.

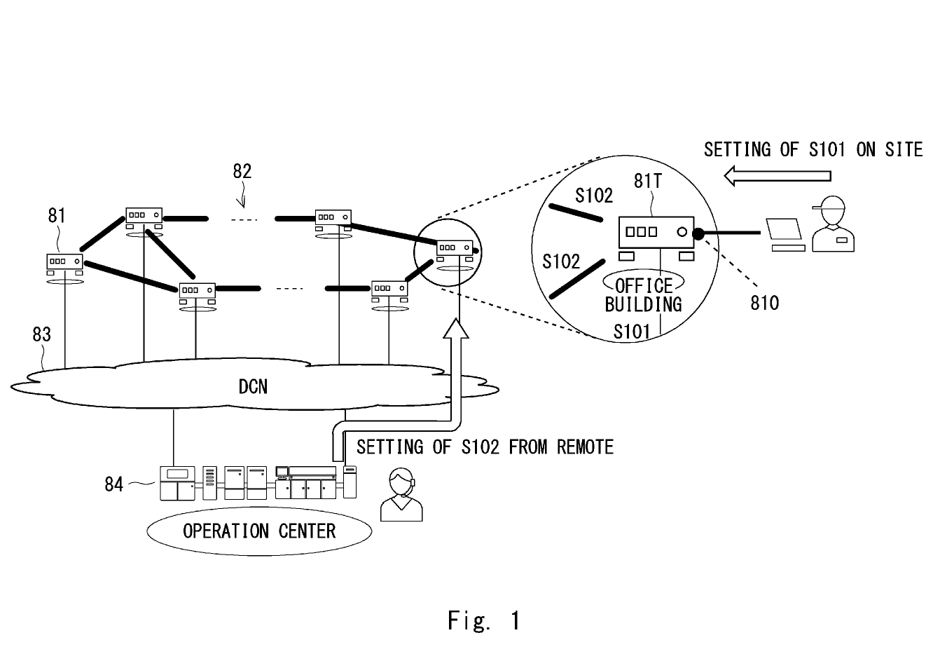

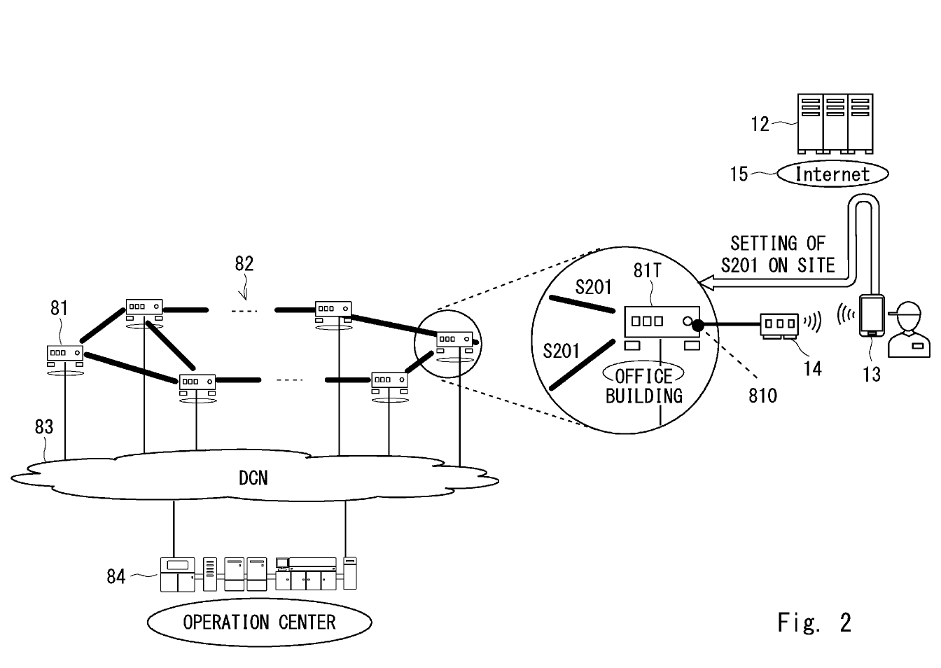

FIG. 2 is a diagram illustrating an image example of maintenance and operation work for an NW device according to the present disclosure. In FIG. 2, similarly to FIG. 1, it is assumed that maintenance and operation work of adding a new NW device 81T to a service NW 82 is performed. In FIG. 2, similarly to FIG. 1, it is assumed that the plurality of NW devices 81 for forming the service NW 82 are connected to a DCN 83, and the control monitoring system 84 is connected to the DCN 83.

As illustrated in FIG. 2, in the present disclosure, a smart device 13 has a mechanism in which the NW device 81T can access the Internet 15 from a management port 810 by using a connection function such as Bluetooth (registered trademark), Universal Serial Bus (USB), 4G (generation)/5G, and WiFi (registered trademark) which are normally included in the smart device.

That is, in the present disclosure, a worker carrying the smart device 13 enters an office building and uses the connection function of the smart device 13 to make the NW device 81T accessible to the Internet 15 from the management port 810. In this state, setting (S201) for incorporating the NW device 81T into the service NW 82 is performed. Therefore, it is possible to perform maintenance and operation work on the NW device 81T in a state where the NW device 81T is not connected to the DCN 83.

### Outline of First Example Embodiment

Next, an outline of the first example embodiment will be described.

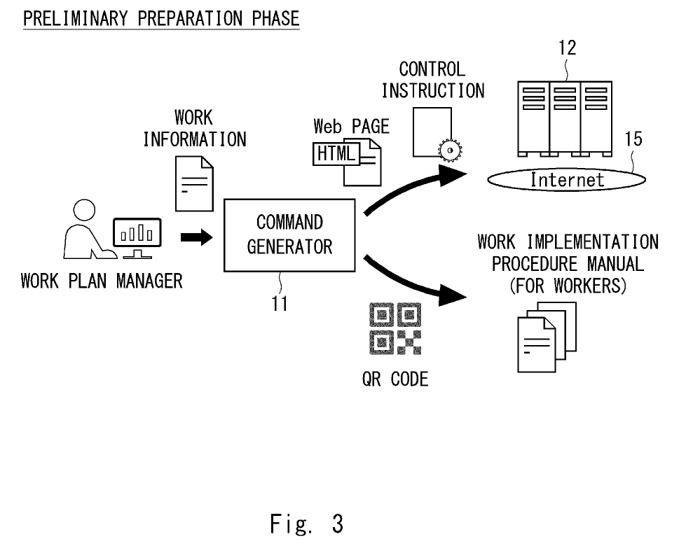

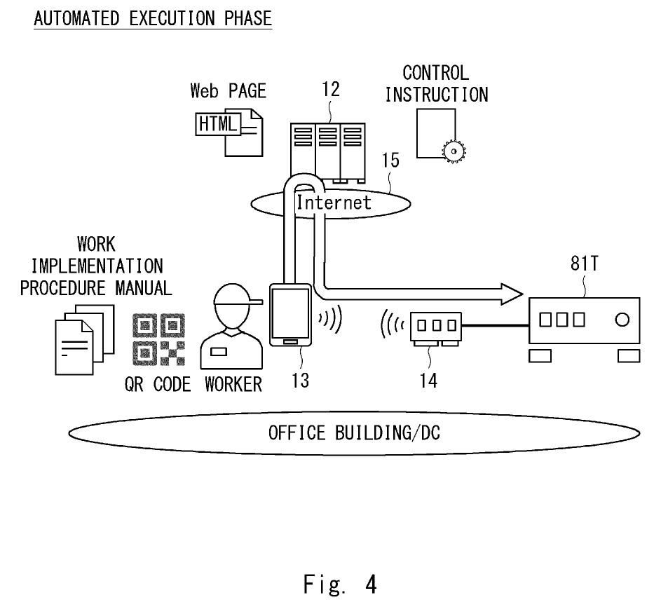

The operation of the first example embodiment is roughly divided into two phases: a preliminary preparation phase illustrated in FIG. 3 and an automated execution phase illustrated in FIG. 4.

First, an operation of the preliminary preparation phase will be described.

FIG. 3 is a diagram illustrating an operation example of the preliminary preparation phase according to the present disclosure.

As illustrated in FIG. 3, in the preliminary preparation phase, a work plan manager who is a manager of the maintenance and operation work first inputs work information including a type of maintenance and operation work and work parameters that are parameters necessary for the maintenance and operation work to a command generator 11.

The command generator 11 generates a control instruction, a web page, and a quick response (QR) code (registered trademark) suitable for the input maintenance and operation work based on input work information. These products are output for each NW device that is a control target. Hereinafter, it is assumed that the control target NW device is the NW device 81T.

The control instruction is an electronic file including commands input to the NW device 81T according to the work procedure of the input maintenance and operation work and information regarding an input order of the commands. The web page is a web page for downloading the control instruction. The QR code is a two-dimensional code in which a character string of a uniform resource locator (URL) for uniquely accessing the web page is encoded.

Before a worker enters a building such as an office building or a data center (hereinafter referred to as a DC) where the NW device 81T is installed (alternatively, the NW device 81T is newly installed) and starts work, the control instruction and the web page are stored in a server 12 on the Internet 15 and the QR code is transmitted to the worker entering the work location. The QR code may be an electronic image or a printed matter, but in FIG. 3, it is assumed that the QR code is printed in a paper work implementation procedure manual carried by the worker.

Next, an operation of the automated execution phase will be described.

FIG. 4 is a diagram illustrating an operation example of the automated execution phase according to the present disclosure.

As illustrated in FIG. 4, in the automated execution phase, actual work of the maintenance and operation work to which the present disclosure is applied is performed.

First, the worker carrying the work implementation procedure manual on which the QR code is printed, the smart device 13, and the control adapter 14 enters a building such as an office building or a DC where the NW device 81T is installed (alternatively, the NW device 81T is newly installed).

Next, the worker connects the NW device 81T and the control adapter 14, and further connects the control adapter 14 and the smart device 13 according to the procedure of the work implementation procedure manual. Accordingly, the NW device 81T can access the Internet 15 via the control adapter 14 and the smart device 13.

Further, the worker advances the maintenance and operation work according to the procedure of the work implementation procedure manual. During the procedure, in the work of reading the QR code, the worker reads the QR code printed in the work implementation procedure manual by using the camera function of the smart device 13. Then, the URL is displayed on a screen of the smart device 13. If the worker touches the URL, a browser of the smart device 13 is started, the server 12 on the Internet 15 is automatically accessed, and a web page is displayed on the screen of the smart device 13.

If the worker checks on the browser that “the control instruction is downloaded and commands are automatically input to the NW device” and presses an execution button in the web page, the control instruction is downloaded to the control adapter 14. Thereafter, the control adapter 14 sequentially inputs commands to the NW device 81T according to the content of the control instruction. That is, the control adapter 14 inputs the commands included in the control instruction to the NW device 81T according to the information regarding the input order included in the control instruction. Accordingly, the maintenance and operation work is completed.

Hereinafter, the first example embodiment will be described in detail.

### Details of First Example Embodiment

First, a configuration of the first example embodiment will be described.

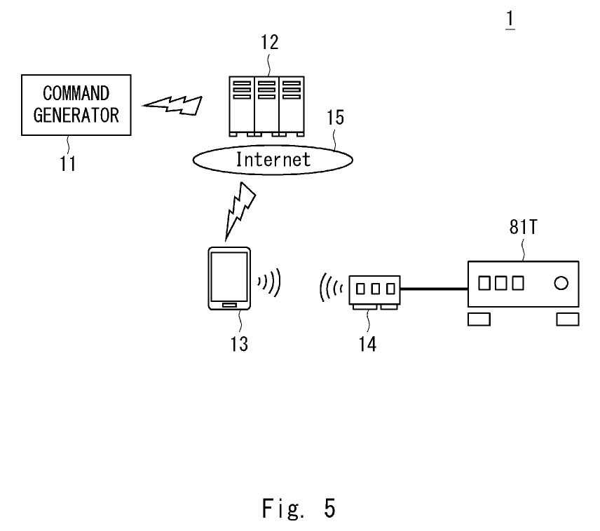

FIG. 5 is a diagram illustrating a configuration example of a maintenance and operation system 1 according to the present disclosure.

As illustrated in FIG. 5, the maintenance and operation system 1 includes the command generator 11, the server 12, the smart device 13, and the control adapter 14.

Hereinafter, individual constituent elements included in the maintenance and operation system 1 will be described.

First, the command generator 11 will be described.

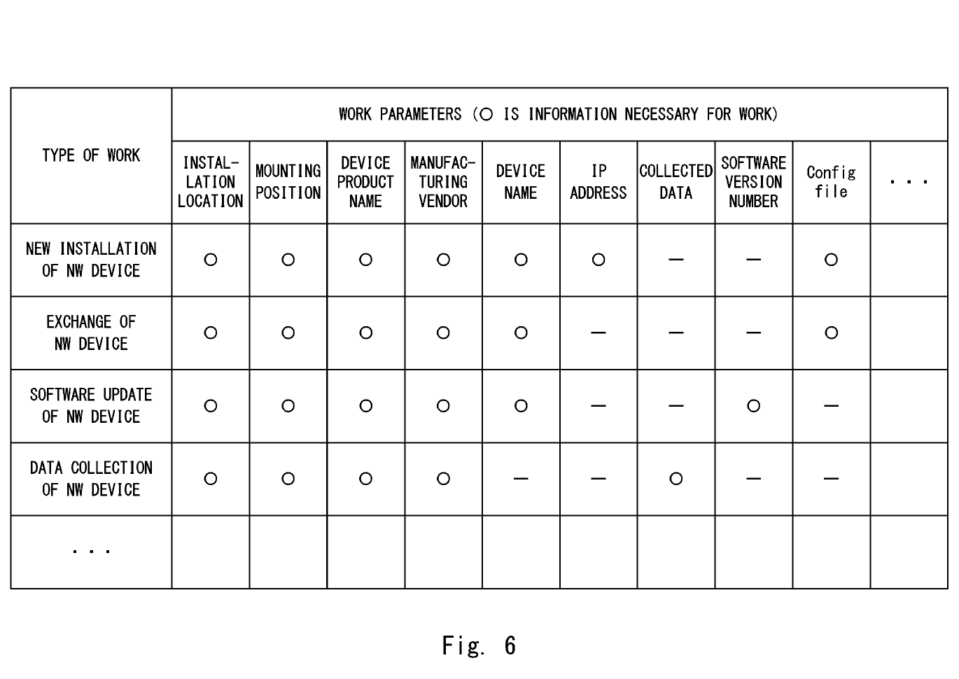

FIG. 6 is a diagram illustrating an example of items of work information input to the command generator 11 according to the present disclosure.

As illustrated in FIG. 6, the work parameters necessary for the maintenance and operation work are set for each type of maintenance and operation work. Therefore, in a case where the work information is input to the command generator 11, the work plan manager first inputs the type of maintenance and operation work, and then inputs the work parameters necessary for the maintenance and operation work. For example, in a case where “new installation of NW device” is input as the type of maintenance and operation work, the work plan manager inputs “installation location”, “mounting position”, “device product name”, “manufacturing vendor”, “device name”, “internet protocol (IP) address”, and “Config file” as the work parameters. As a method of inputting the work information, there is a method of inputting the work information to the command generator 11 using a graphical user interface (GUI). As another method, there is a method of describing a plurality of types of maintenance and operation work and work parameters of each of the plurality of types of maintenance and operation work in an electronic file with a comma separated values (CSV) format and importing the electronic file into the command generator 11.

Based on the input work information, the command generator 11 generates and outputs three items: a control instruction including commands according to the work procedure of the input maintenance and operation work and information regarding an input order of the commands, a web page for downloading the control instruction, and a QR code obtained by encoding a character string of a URL for uniquely accessing the web page.

The control instruction and the web page generated by the command generator 11 are stored in the server 12 on the Internet 15. It is assumed that the control instruction and the web page are directly output from the command generator 11 to the server 12 by a wireless or wired communication function. However, the present disclosure is not limited thereto, and the control instruction and the web page may be output to a separate device and may be output from the separate device to the server 12.

On the other hand, the QR code generated by the command generator 11 is transmitted to a worker who enters a work location. For example, the QR code is printed on a paper work implementation procedure manual brought by the worker in FIG. 3.

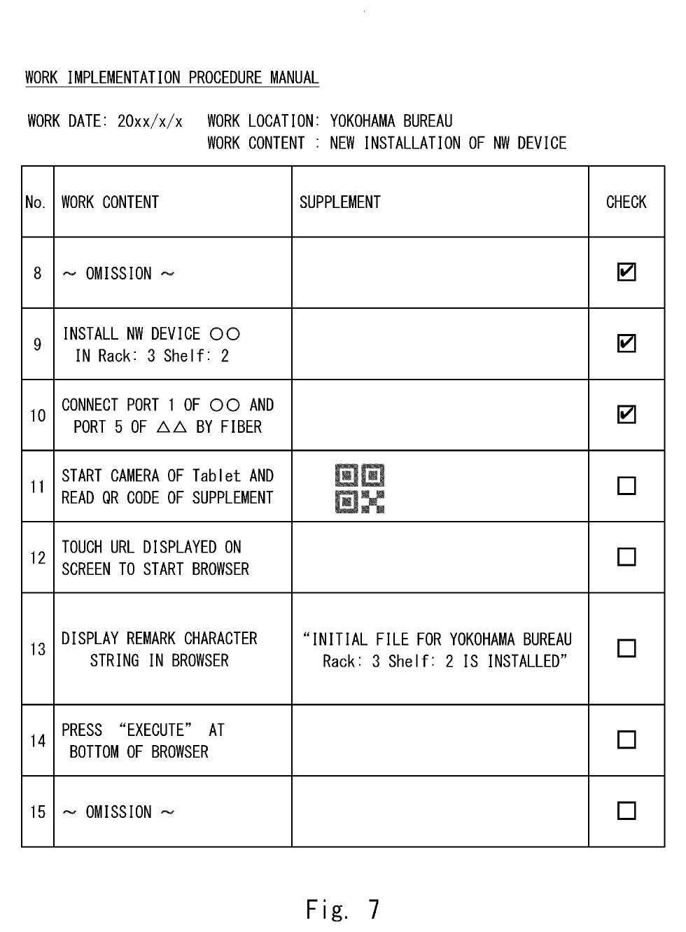

FIG. 7 is a diagram illustrating an example of a work implementation procedure manual according to the present disclosure.

As illustrated in FIG. 7, in the work implementation procedure manual, work content performed by the worker on the day of work is described in order of work. In the example of FIG. 7, the QR code output from the command generator 11 is attached to a supplementary field next to work content of No. 11. In FIG. 3, the work implementation procedure manual is paper, but may be an electronic file.

Next, the server 12 will be described.

The server 12 is a server provided on the Internet 15, and has a function of storing the control instruction and the web page output from the command generator 11. The server 12 also has a function of transferring a control instruction to the control adapter 14 via the smart device 13. For example, in a case where the worker presses an execution button in a web page displayed on a screen of the smart device 13, the server 12 transfers the control instruction to the control adapter 14.

Next, the control adapter 14 and the smart device 13 will be described.

The control adapter 14 is a general-purpose small device that has a palm size and plays a role of relaying communication between the NW device 81T and the smart device 13 and a role of inputting the commands to the NW device 81T according to the control instruction. For example, general-purpose software that has a function of sequentially inputting the commands based on content of the control instruction may be incorporated in the control adapter 14.

Here, a connection protocol between the control adapter 14 and the NW device 81T, the commands input to the NW device 81T, and an input order of the commands are different depending on specification of a vendor and a product. However, these differences are all absorbed in the control instruction.

The smart device 13 is a general-purpose product such as a smartphone or a tablet that is carried and held by a worker for contact with a person concerned.

Here, the smart device 13 normally has a wireless connection function of accessing the Internet 15 via a 4G/5G line or WiFi.

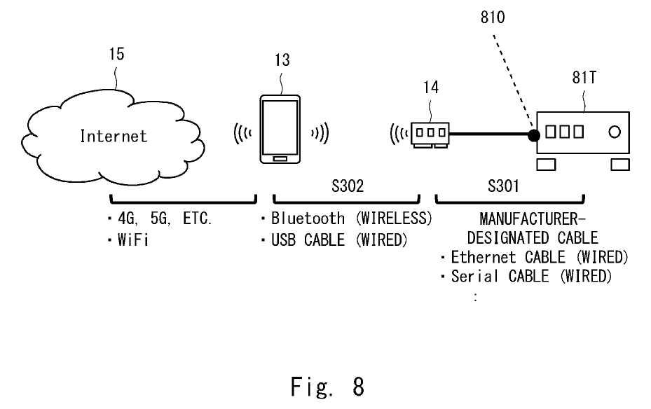

FIG. 8 is a diagram illustrating an example of a method of connecting the smart device 13 and the control adapter 14 according to the present disclosure.

As illustrated in FIG. 8, in step S301, the NW device 81T and the control adapter 14 are connected. For example, the control adapter 14 is physically connected to the management port 810 that controls the NW device 81T by a cable (such as an Ethernet (registered trademark) cable or a serial cable) designated by a manufacturer of the NW device 81T.

In step S302, the control adapter 14 and the smart device 13 are connected. For example, by pressing a Bluetooth connection button of the smart device 13, the control adapter 14 and the smart device 13 are connected by Bluetooth. However, the Bluetooth connection is not suitable for transmission and reception of data that has a large size. Therefore, in a case where such transmission and reception are performed, the control adapter 14 and the smart device 13 may be connected by a USB cable.

If the connection in steps S301 and S302 is completed, the NW device 81T can access the Internet 15 via the control adapter 14 and the smart device 13.

The smart device 13 typically has a camera function. A worker uses the camera function to read a QR code attached to a work implementation procedure manual. If the QR code is read, the URL is displayed on the screen. If the worker touches the URL, the browser is started, the server 12 on the Internet 15 is accessed and a web page is displayed on the screen. If the worker presses the execution button in the web page, the control instruction is downloaded to the control adapter 14 via the smart device 13.

Next, an operation of the first example embodiment will be described.

First, an operation of the preliminary preparation phase will be described.

As illustrated in FIG. 3, the work plan manager first inputs work information including a type of maintenance and operation work and work parameters necessary for the maintenance and operation work to the command generator 11. Then, the command generator 11 generates a control instruction, a web page, and a QR code based on the input work information.

Here, an operation of the command generator 11 will be described in detail.

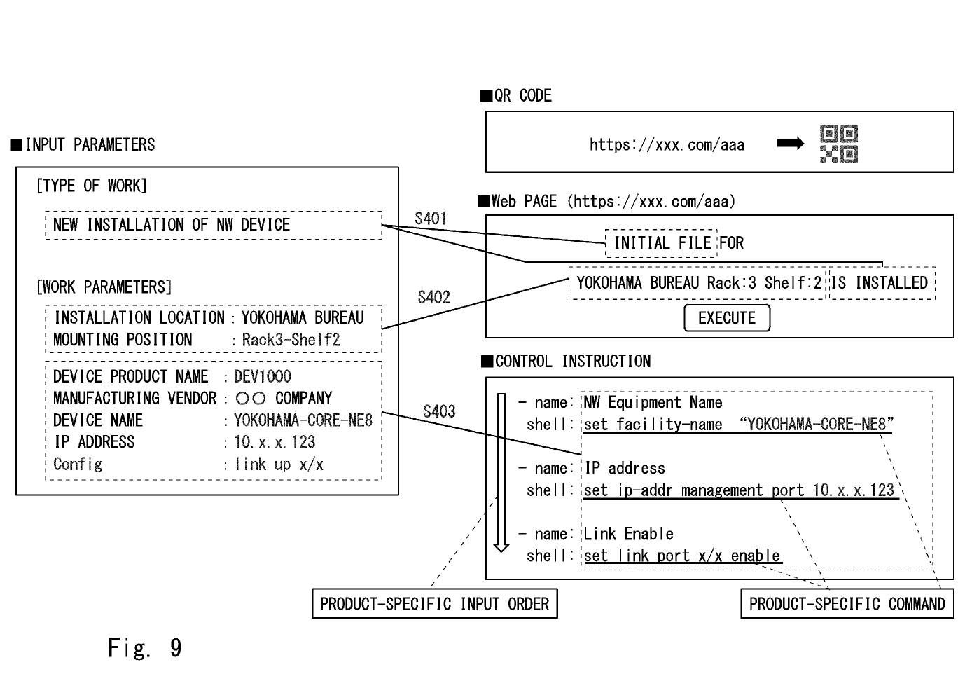

FIG. 9 is a diagram illustrating an operation example of the command generator 11 according to the present disclosure.

As illustrated in FIG. 9, the command generator 11 generates a web page and a control instruction by performing conversion in steps S401, S402, and S403 on the input work information. At this time, the command generator 11 generates a web page dedicated to the NW device 81T based on the information of the type of the maintenance and operation work, an installation location, and a mounting position delivered as the work information. The command generator 11 generates a control instruction dedicated to the NW device 81T in which character strings of unique commands based on the specifications of the device product are arranged in a unique input order based on the information regarding a device product name, a manufacturing vendor, a device name, an IP address, and a Config file delivered as the work information.

The command generator 11 generates a QR code by encoding a character string of a URL for uniquely accessing the web page.

The control instruction and the web page generated by the command generator 11 are stored in the server 12 on the Internet 15. The QR code generated by the command generator 11 is transmitted to the worker. For example, the QR code is printed in the supplementary field next to relevant work content in the paper work implementation procedure manual carried by the worker.

Next, an operation of the automated execution phase will be described.

As illustrated in FIG. 4, the worker carrying the work implementation procedure manual, the smart device 13, and the control adapter 14 first enters a building such as an office building or a DC in which the NW device 81T is installed (alternatively, the NW device 81T is newly installed).

Next, the worker performs connection work of connecting the NW device 81T to the control adapter 14, and connection work of connecting the control adapter 14 to the smart device 13. If the connection work is completed, the NW device 81T can access the Internet 15 via the control adapter 14 and the smart device 13.

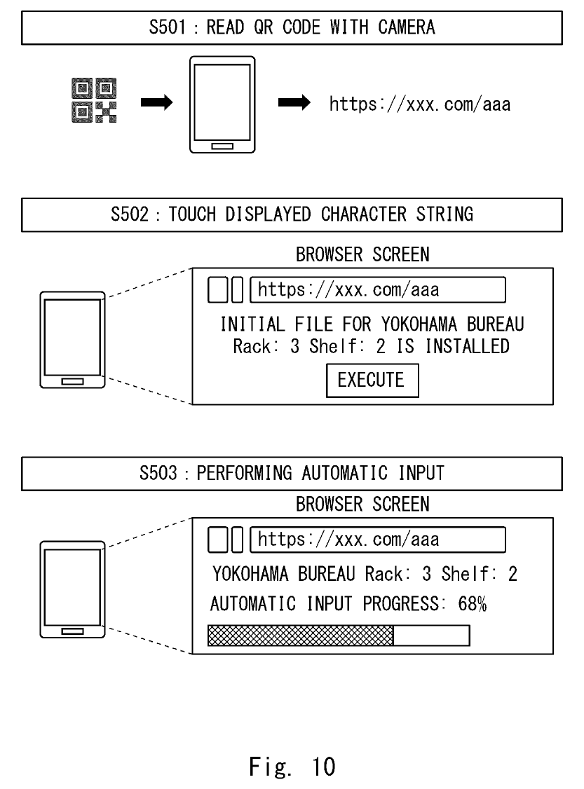

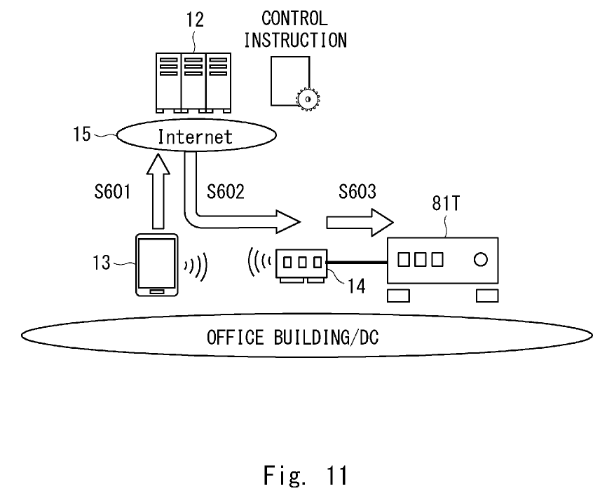

Subsequent operations will be described by taking, as an example, the work of installing the new NW device 81T along the work implementation procedure manual illustrated in FIG. 7, FIGS. 10 and 11.

FIG. 10 is a diagram illustrating an example of screen transition of the smart device 13 according to the present disclosure. FIG. 11 is a diagram illustrating an operation example of the automated execution phase by the smart device 13, the server 12, and the control adapter 14 according to the present disclosure.

Here, as described above, the worker completes the connection work of connecting the NW device 81T to the control adapter 14 and the connection work of connecting the control adapter 14 to the smart device 13. Therefore, it is assumed that the procedures until the work content of No. 10 in FIG. 7 are completed.

Next, the worker reads the QR code attached to the supplementary field using the camera function of the smart device 13 (a tablet in FIG. 7) according to work content of No. 11 in FIG. 7. Then, the URL is displayed on the screen of the smart device 13 (step S501 in FIG. 10).

Next, the worker touches the URL displayed on the screen of the smart device 13 according to the work content of No. 12 in FIG. 7. Then, the browser of the smart device 13 is started, the server 12 on the Internet 15 is accessed, and a web page is displayed on the screen of the smart device 13 (step S502 in FIG. 10). At this time, since the above read QR code is obtained by encoding the character string of the URL for uniquely accessing the web page dedicated to the NW device 81T, the web page displayed in step S502 of FIG. 10 is the web page dedicated to the NW device 81T. Therefore, a sentence (in the example of FIG. 10, "Initial file for Yokohama Bureau Rack: 3 Shelf: 2 is installed”) dedicated to the NW device 81T is displayed on the web page dedicated to the NW device 81T.

Next, the worker checks that the sentence described in the supplementary field on the side is displayed on the screen of the smart device 13 according to the work content of No. 13 in FIG. 7. Accordingly, the worker can check that a correct process is performed for the NW device (the NW device 81T) described in the work content of No. 9 in FIG. 7.

Next, the worker presses the execution button in the web page displayed in step S502 in FIG. 10 according to the work content of No. 14 in FIG. 7. Then, subsequent command input work to the NW device 81T is automatically executed without the worker being involved at all.

In practice, if the execution button in the web page displayed on the screen of the smart device 13 is pressed (step S601 in FIG. 11), a process associated with the execution button, that is, a process of transferring the control instruction from the server 12 to the control adapter 14 via the smart device 13 is started (step S602 in FIG. 11).

If the control instruction is received from the server 12, the control adapter 14 sequentially and automatically inputs the commands to the NW device 81T according to the content of the control instruction (step S603 in FIG. 11). A progress status of the automatic input of the commands from the control adapter 14 is displayed in real time in a web page on the screen of the smart device 13 (step S503 in FIG. 10). Therefore, the worker can know the progress status and completion of the automatic input of the commands. In this way, all the control of the maintenance and operation work on the NW device 81T can be automated.

As described above, according to the first example embodiment, the work information including the type of maintenance and operation work and the work parameters necessary for the maintenance and operation work is input to the command generator 11. Based on the input work information, the command generator 11 generates the control instruction including the commands to be input to the control target NW device 81T and the information regarding the input order of the commands, the web page for downloading the control instruction, and the QR code obtained by encoding a character string of a URL for accessing the web page. The control instruction and the web page are stored in the server 12 on the Internet 15, and the QR code is attached to the work implementation procedure manual. The control adapter 14 is connected to the NW device 81T and the smart device 13 and enables access from the NW device 81T to the Internet 15. If the QR code attached to the work implementation procedure manual is read by the worker using the camera function of the smart device 13, the URL is displayed on the screen. If the worker touches the URL, the smart device 13 accesses the server 12 and displays a web page on the screen. If the worker presses the execution button in the web page, the control instruction is downloaded from the server 12 to the control adapter 14. The control adapter 14 sequentially inputs the commands to the NW device 81T according to the control instruction.

Therefore, according to the first example embodiment, it is possible to perform the maintenance and operation work on the NW device 81T without connecting the control target NW device 81T to the DCN 83. In an environment where the smart device 13 can access the Internet 15, the maintenance and operation work for the NW device 81T can be executed. Therefore, it is possible to relax restriction of the work location where the maintenance and operation work is performed. In a situation where the control adapter 14 is connected to the NW device 81T and the smart device 13 can be connected to the control adapter 14, for example, the worker is not required to enter an office building to perform software update work or the like of the NW device 81T and can perform the software update work in the office. In this case, since the worker is not required to move to a local office building, the maintenance and operation work can be performed very efficiently.

In the first example embodiment, the following effects can also be obtained.

### Another Effect 1

According to some related arts, command input work to the NW device 81T is manually performed. On the other hand, according to the first example embodiment, the command input work to the NW device 81T is automated. Accordingly, a work time of the maintenance and operation work can be significantly shortened. The automated command input work can be performed in parallel on the plurality of NW devices 81T, which also greatly contributes to shortening of the work time.

### Another Effect 2

According to the related arts, the NW device 81T itself has a function of acquiring an IP address, reading control data, and performing a process. However, since whether the NW device 81T has the function depends on specifications of a vendor and a product, the maintenance and operation work can be performed only on some NW devices 81T that have the function. On the other hand, according to the first example embodiment, since the NW device 81T is not required to have the above-described functions, the maintenance and operation work can be uniformly performed on all the NW devices 81T by the same method. Therefore, the maintenance and operation work can be simplified.

### Another Effect 3

The content of the maintenance and operation work for the NW device 81T is various in accordance with the product and the vendor. However, according to the first example embodiment, since the work parameters input to the command generator 11 include information regarding the product and the vendor, the command generator 11 can generate the control instruction appropriate for the product and the vendor of the NW device 81T. In other words, the command generator 11 can absorb differences between the products and the vendors. Therefore, even if there are the differences between the products and the vendors, the maintenance and operation work on the NW device 81T can be performed. Even in a case where a new product or a new vendor is adopted, a generation logic of the control instruction of the command generator 11 only needs to match the new product or the new vendor, which can reduce development cost.

### Another Effect 4

According to the first example embodiment, preliminary connection work is only work of connecting the control adapter 14 to the NW device 81T by Bluetooth connection or the like and work of connecting the control adapter 14 to the smart device 13 by a cable, and thus this work is very easy. All the commands input to the NW device 81T are expressed in the control instruction. Therefore, for any type of maintenance and operation work, the worker only needs to uniformly perform the same procedure as the work content of No. 11 to No. 14 in FIG. 7. Therefore, learning cost for training the worker preliminarily can be minimized.

### Another Effect 5

According to the first example embodiment, the worker only reads the QR code with the camera function of the smart device 13, touches the URL, and presses the execution button, and thus does not input any character string or numerical value. Therefore, it is possible to completely eliminate an error of the maintenance and operation work caused due to an input error of the worker. Therefore, no matter who the worker is, it is possible to perform the maintenance and operation work of equally high quality.

### Another Effect 6

As described above, according to some related arts, the command input work to the NW device 81T is manually performed. However, if an erroneous command is input to the NW device 81T, this may affect, in the worst case, a service that is being operated in the service NW 82. Therefore, it is very important to input a correct command to the correct NW device 81T, and the maintenance and operation work on the NW device 81T requires work reliability. On the other hand, according to the first example embodiment, as described with reference to No. 9 and No. 13 in FIG. 7 and step S502 in FIG. 10, the worker can check the process performed on the NW device 81T. Accordingly, since the worker can check whether the correct commands are input to the correct NW device 81T, it is possible to ensure the reliability of the maintenance and operation work through the eyes of the worker.

### Another Effect 7

In the related art illustrated in FIG. 1, there are work that can be performed only by an entry worker who enters a local office building and work that can be performed only by a remote worker, and it is necessary to secure workers at the site and at the remote site. On the other hand, according to the first example embodiment, since all the procedures of the maintenance and operation work are completed only by the entry workers, the number of workers to be secured can be optimized.

### Another Effect 8

According to the first example embodiment, as the function of the smart device 13, only functions that are installed as standards in many general-purpose smart devices such as a Bluetooth connection function, a USB connection function, a camera function, a QR code reading function, and a browser function are used. Therefore, a general-purpose product itself can be used as the smart device 13. The smart device 13 does not depend on a type of operating system (OS) and does not require a special setting change. In the smart device 13, it is not necessary to install a dedicated application. Accordingly, it is possible to lower the hurdle for introducing the method of the present disclosure.

### Second Example Embodiment

### Image of Second Example Embodiment

First, an image of a second example embodiment will be described.

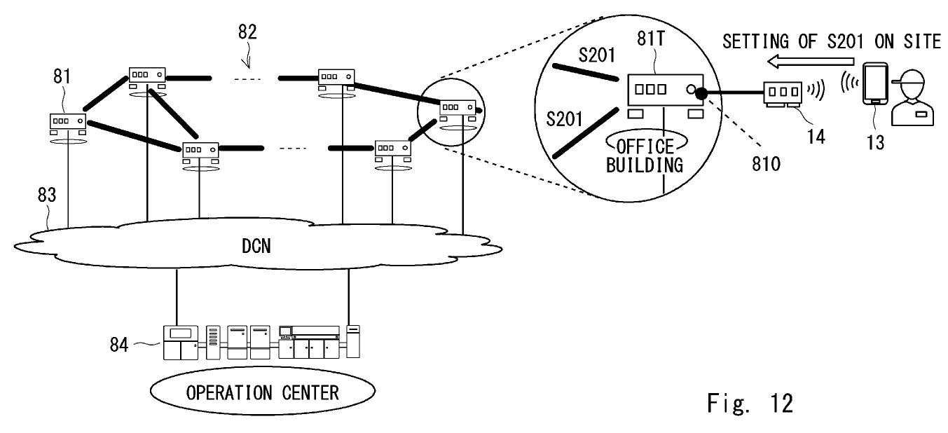

FIG. 12 is a diagram illustrating an image example of maintenance and operation work for an NW device according to the present disclosure. In FIG. 12, similarly to FIG. 1, it is assumed that maintenance and operation work of adding a new NW device 81T to the service NW 82 is performed. In FIG. 12, similarly to FIG. 1, it is assumed that the plurality of NW devices 81 forming the service NW 82 are connected to the DCN 83, and the control monitoring system 84 is connected to the DCN 83.

As illustrated in FIG. 12, in the present disclosure, the control adapter 14 has a mechanism holding a control instruction for incorporating the NW device 81T into the service NW 82.

That is, in the present disclosure, the worker carrying the control adapter 14 that holds the control instruction enters an office building. Then, setting (S201) for incorporating the NW device 81T into the service NW 82 is performed. Therefore, it is possible to perform maintenance and operation work on the NW device 81T in a state where the NW device 81T is not connected to the DCN 83.

### Outline of Second Example Embodiment

Next, an outline of the second example embodiment will be described.

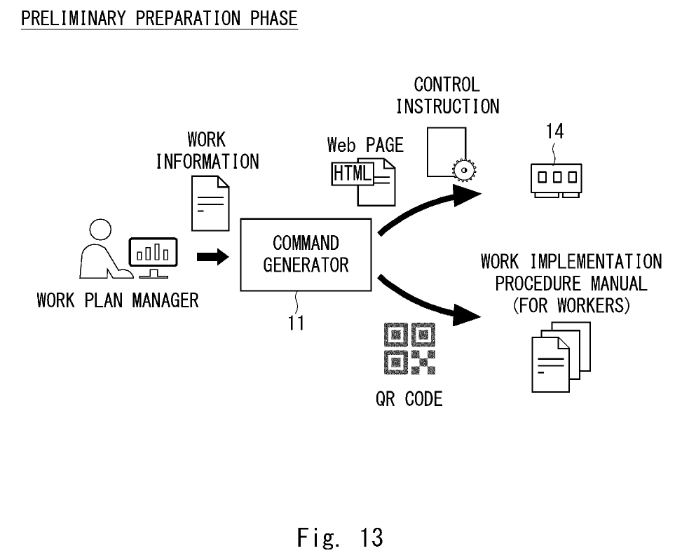

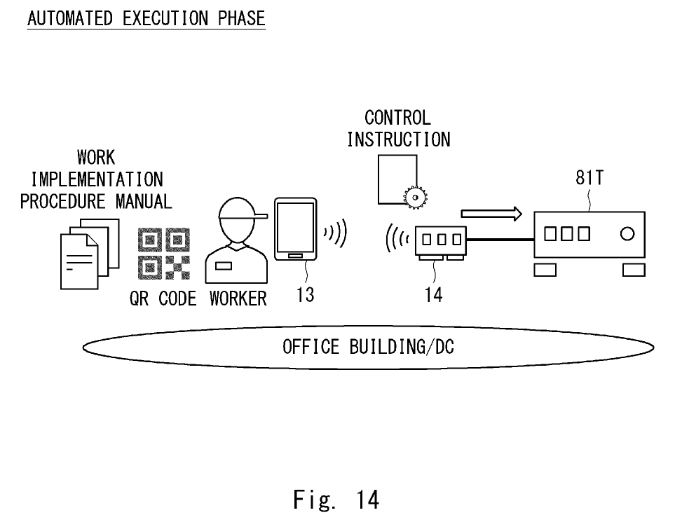

The operation of the second example embodiment is roughly divided into two phases: a preliminary preparation phase illustrated in FIG. 13 and an automated execution phase illustrated in FIG. 14.

First, an operation of the preliminary preparation phase will be described.

FIG. 13 is a diagram illustrating an operation example of the preliminary preparation phase according to the present disclosure.

As illustrated in FIG. 13, in the preliminary preparation phase, the work plan manager who is the manager of the maintenance and operation work first inputs work information including a type of maintenance and operation work and work parameters that are parameters necessary for the maintenance and operation work to the command generator 11.

The command generator 11 generates a control instruction, a web page, and a QR code suitable for the input maintenance and operation work based on the input work information. These products are output for each NW device that is a control target. Hereinafter, it is assumed that the control target NW device is the NW device 81T.

The control instruction is an electronic file including commands input to the NW device 81T according to the work procedure of the input maintenance and operation work and information regarding an input order of the commands. The web page is a web page for executing the control instruction. The QR code is a two-dimensional code in which a character string of a URL for uniquely accessing the web page is encoded.

Before a worker enters a building such as an office building or a DC where the NW device 81T is installed (alternatively, the NW device 81T is newly installed) and starts work, the control instruction and the web page are stored in the control adapter 14, and the QR code is transmitted to the worker who enters the work location. The QR code may be an electronic image or a printed matter, but in FIG. 13, it is assumed that the QR code is printed in a paper work implementation procedure manual carried by the worker.

Next, an operation of the automated execution phase will be described.

FIG. 14 is a diagram illustrating an operation example of the automated execution phase according to the present disclosure.

As illustrated in FIG. 14, in the automated execution phase, actual work of the maintenance and operation work to which the present disclosure is applied is performed.

First, the worker carrying the work implementation procedure manual on which the QR code is printed, the smart device 13, and the control adapter 14 enters a building such as an office building or a DC where the NW device 81T is installed (alternatively, the NW device 81T is newly installed).

Next, the worker connects the NW device 81T and the control adapter 14, and further connects the control adapter 14 and the smart device 13 according to the procedure of the work implementation procedure manual. Accordingly, the NW device 81T can access the control adapter 14.

Further, the worker advances the maintenance and operation work according to the procedure of the work implementation procedure manual. During the procedure, in the work of reading the QR code, the worker reads the QR code printed in the work implementation procedure manual by using the camera function of the smart device 13. Then, the URL is displayed on a screen of the smart device 13. If the worker touches the URL, a browser of the smart device 13 is started, the control adapter 14 is automatically accessed, and a web page is displayed on the screen of the smart device 13.

If the worker checks on the browser that “the commands are automatically input to the NW device” and presses an execution button in the web page, the control adapter 14 sequentially inputs the commands to the NW device 81T according to the content of the control instruction. That is, the control adapter 14 inputs the commands included in the control instruction to the NW device 81T according to the information regarding the input order included in the control instruction. Accordingly, the maintenance and operation work is completed.

Hereinafter, the second example embodiment will be described in detail.

### Details of Second Example Embodiment

First, a configuration of the second example embodiment will be described.

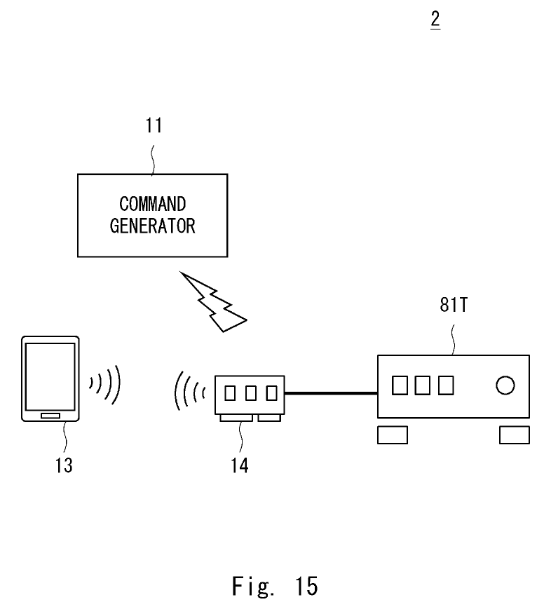

FIG. 15 is a diagram illustrating a configuration example of a maintenance and operation system 2 according to the present disclosure.

As illustrated in FIG. 15, the maintenance and operation system 2 includes a command generator 11, a smart device 13, and a control adapter 14.

Hereinafter, individual constituent elements included in the maintenance and operation system 2 will be described.

First, the command generator 11 will be described.

As illustrated in FIG. 6, the work parameters necessary for the maintenance and operation work are set for each type of maintenance and operation work. Therefore, in a case where the work information is input to the command generator 11, the work plan manager first inputs the type of maintenance and operation work, and then inputs the work parameters necessary for the maintenance and operation work. For example, in a case where “new installation of NW device” is input as the type of maintenance and operation work, the work plan manager inputs “installation location”, “mounting position”, “device product name”, “manufacturing vendor”, “device name”, “IP address”, and “Config file” as the work parameters. As a method of inputting the work information, there is a method of inputting the work information to the command generator 11 using a GUI. As another method, there is a method of describing a plurality of types of maintenance and operation work and work parameters of each of the plurality of types of maintenance and operation work in an electronic file in a CSV format and importing the electronic file into the command generator 11.

Based on the input work information, the command generator 11 generates and outputs three items: a control instruction including commands according to the work procedure of the input maintenance and operation work and information regarding the input order of the commands, a web page for executing the control instruction, and a QR code obtained by encoding a character string of a URL for uniquely accessing the web page.

The control instruction and the web page generated by the command generator 11 are stored in the control adapter 14. It is assumed that the control instruction and the web page are directly output from the command generator 11 to the control adapter 14 by a wireless or wired communication function. However, the present disclosure is not limited thereto, and the control instruction and the web page may be output to a separate device and may be output from the separate device to the control adapter 14.

On the other hand, the QR code generated by the command generator 11 is transmitted to a worker who enters a work location. For example, the QR code is printed in a paper work implementation procedure manual brought by the worker in FIG. 13.

As illustrated in FIG. 7, in the work implementation procedure manual, work content performed by the worker on the day of work is described in order of work. In the example of FIG. 7, the QR code output from the command generator 11 is attached to a supplementary field next to work content of No. 11. In FIG. 13, the work implementation procedure manual is paper, but may be an electronic file.

Next, the control adapter 14 and the smart device 13 will be described.

The control adapter 14 is a general-purpose small device that has a palm size and plays a role of relaying communication between the NW device 81T and the smart device 13, a role of storing a control instruction, and a role of inputting the commands to the NW device 81T according to the control instruction. For example, general-purpose software that has a function of sequentially inputting the commands based on content of the control instruction may be incorporated in the control adapter 14.

Here, a connection protocol between the control adapter 14 and the NW device 81T, the commands input to the NW device 81T, and an input order of the commands are different depending on specification of a vendor and a product. However, these differences are all absorbed in the control instruction.

The smart device 13 is a general-purpose product such as a smartphone or a tablet that is carried and held by a worker for contact with a person concerned.

The smart device 13 can access the control adapter 14 via Bluetooth or a USB cable.

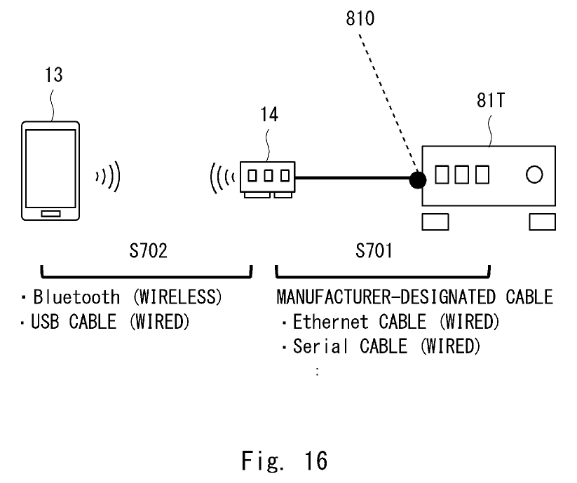

FIG. 16 is a diagram illustrating an example of a method of connecting the smart device 13 and the control adapter 14 according to the present disclosure.

As illustrated in FIG. 16, in step S701, the NW device 81T and the control adapter 14 are connected. For example, the control adapter 14 is physically connected to the management port 810 that controls the NW device 81T by a cable (such as an Ethernet cable or a serial cable) designated by the manufacturer of the NW device 81T.

In step S702, the control adapter 14 and the smart device 13 are connected. For example, by pressing a Bluetooth connection button of the smart device 13, the control adapter 14 and the smart device 13 are connected by Bluetooth. However, the Bluetooth connection is not suitable for transmission and reception of data that has a large size. Therefore, in a case where such transmission and reception are performed, the control adapter 14 and the smart device 13 may be connected by a USB cable.

The smart device 13 typically has a camera function. A worker uses the camera function to read a QR code attached to a work implementation procedure manual. If the QR code is read, the URL is displayed on the screen. If the worker touches the URL, the browser is started, the control adapter 14 is accessed and a web page is displayed on the screen. If the worker presses the execution button in the web page, the control adapter 14 sequentially inputs the commands to the NW device 81T according to the content of the control instruction.

Next, an operation of the second example embodiment will be described.

First, an operation of the preliminary preparation phase will be described.

As illustrated in FIG. 13, the work plan manager first inputs work information including a type of maintenance and operation work and work parameters necessary for the maintenance and operation work to the command generator 11. Then, the command generator 11 generates a control instruction, a web page, and a QR code based on the input work information.

Here, an operation of the command generator 11 will be described in detail.

As illustrated in FIG. 9, the command generator 11 generates a web page and a control instruction by performing conversion in steps S401, S402, and S403 on the input work information. At this time, the command generator 11 generates a web page dedicated to the NW device 81T based on the information of the type of the maintenance and operation work, an installation location, and a mounting position delivered as the work information. The command generator 11 generates a control instruction dedicated to the NW device 81T in which character strings of unique commands based on the specifications of the device product are arranged in a unique input order based on the information regarding a device product name, a manufacturing vendor, a device name, an IP address, and a Config file delivered as the work information.

The command generator 11 generates a QR code by encoding a character string of a URL for uniquely accessing the web page.

The control instruction and the web page generated by the command generator 11 are stored in the control adapter 14. The QR code generated by the command generator 11 is transmitted to the worker. For example, the QR code is printed in the supplementary field next to relevant work content in the paper work implementation procedure manual carried by the worker.

Next, an operation of the automated execution phase will be described.

As illustrated in FIG. 14, the worker carrying the work implementation procedure manual, the smart device 13, and the control adapter 14 first enters a building such as an office building or a DC in which the NW device 81T is installed (alternatively, the NW device 81T is newly installed).

Next, the worker performs connection work of connecting the NW device 81T to the control adapter 14, and connection work of connecting the control adapter 14 to the smart device 13. If the connection work is completed, the smart device 13 can access the NW device 81T via the control adapter 14.

Subsequent operations will be described by taking, as an example, the work of installing the new NW device 81T along the work implementation procedure manual illustrated in FIG. 7 and FIG. 10.

Here, as described above, the worker completes the connection work of connecting the NW device 81T to the control adapter 14 and the connection work of connecting the control adapter 14 to the smart device 13. Therefore, it is assumed that the procedures until the work content of No. 10 in FIG. 7 are completed.

Next, the worker reads the QR code attached to the supplementary field using the camera function of the smart device 13 (a tablet in FIG. 7) according to work content of No. 11 in FIG. 7. Then, the URL is displayed on the screen of the smart device 13 (step S501 in FIG. 10).

Next, the worker touches the URL displayed on the screen of the smart device 13 according to the work content of No. 12 in FIG. 7. Then, the browser of the smart device 13 is started, the control adapter 14 is accessed, and a web page is displayed on the screen of the smart device 13 (step S502 in FIG. 10). At this time, since the above read QR code is obtained by encoding the character string of the URL for uniquely accessing the web page dedicated to the NW device 81T, the web page displayed in step S502 of FIG. 10 is the web page dedicated to the NW device 81T. Therefore, a sentence (in the example of FIG. 10, "Initial file for Yokohama Bureau Rack: 3 Shelf: 2 is installed”) dedicated to the NW device 81T is displayed on the web page dedicated to the NW device 81T.

Next, the worker checks that the sentence described in the supplementary field on the side is displayed on the screen of the smart device 13 according to the work content of No. 13 in FIG. 7. Accordingly, the worker can check that a correct process is performed for the NW device (the NW device 81T) described in the work content of No. 9 in FIG. 7.

Next, the worker presses the execution button in the web page displayed in step S502 in FIG. 10 according to the work content of No. 14 in FIG. 7. Then, subsequent command input work to the NW device 81T is automatically executed without the worker being involved at all.

In practice, if an execution button in a web page displayed on the screen of the smart device 13 is pressed, a process associated with the execution button, that is, a process in which the control adapter 14 sequentially and automatically inputs the commands to the NW device 81T according to the content of the control instruction is started. A progress status of the automatic input of the commands from the control adapter 14 is displayed in real time in a web page on the screen of the smart device 13 (step S503 in FIG. 10). Therefore, the worker can know the progress status and completion of the automatic input of the commands. In this way, all the control of the maintenance and operation work on the NW device 81T can be automated.

As described above, according to the second example embodiment, the work information including the type of maintenance and operation work and the work parameter necessary for the maintenance and operation work is input to the command generator 11. Based on the input work information, the command generator 11 generates a control instruction including the commands to be input to the control target NW device 81T and the information regarding the input order of the commands, the web page for executing the control instruction, and the QR code obtained by encoding a character string of a URL for accessing the web page. The control instruction and the web page are stored in the control adapter 14, and the QR code is attached to the work implementation procedure manual. The control adapter 14 is connected to the NW device 81T and the smart device 13. If the QR code attached to the work implementation procedure manual is read by the worker using the camera function of the smart device 13, the URL is displayed on the screen. If the worker touches the URL, the smart device 13 accesses the control adapter 14 and displays a web page on the screen. If the worker presses the execution button in the web page, the control adapter 14 sequentially inputs the commands to the NW device 81T according to the control instruction.

Therefore, according to the second example embodiment, it is possible to perform maintenance and operation work on the NW device 81T without connecting the control target NW device 81T to the DCN 83. In a situation where the control adapter 14 is connected to the NW device 81T and the smart device 13 can be connected to the control adapter 14, for example, the worker is not required to enter an office building to perform software update work or the like of the NW device 81T and can perform the software update work in the office. In this case, since the worker is not required to move to a local office building, the maintenance and operation work can be performed very efficiently.

According to the second example embodiment, it is possible to obtain effects similar to those of the first example embodiment described above (the other effects 1 to 8 described above).

### Third Example Embodiment

### Image of Third Example Embodiment

First, an image of a third example embodiment will be described.

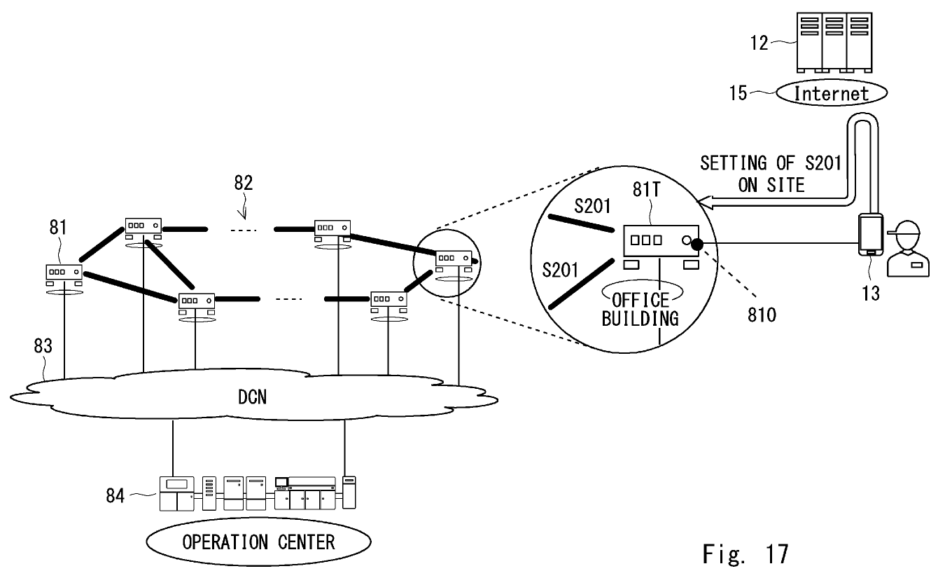

FIG. 17 is a diagram illustrating an image example of maintenance and operation work for the NW device according to the present disclosure. In FIG. 17, similarly to FIG. 1, it is assumed that maintenance and operation work of adding a new NW device 81T to the service NW 82 is performed. In FIG. 17, similarly to FIG. 1, it is assumed that the plurality of NW devices 81 forming the service NW 82 are connected to the DCN 83, and the control monitoring system 84 is connected to the DCN 83.

As illustrated in FIG. 17, the present disclosure has a mechanism in which the NW device 81T can access the Internet 15 from the management port 810 using a connection function such as Bluetooth, USB, 4G/5G, or WiFi that is normally included in the smart device 13.

That is, in the present disclosure, a worker carrying the smart device 13 enters an office building and uses the connection function of the smart device 13 to make the NW device 81T accessible to the Internet 15 from the management port 810. In this state, setting (S201) for incorporating the NW device 81T into the service NW 82 is performed. Therefore, it is possible to perform maintenance and operation work on the NW device 81T in a state where the NW device 81T is not connected to the DCN 83.

### Outline of Third Example Embodiment

Next, an outline of the third example embodiment will be described.

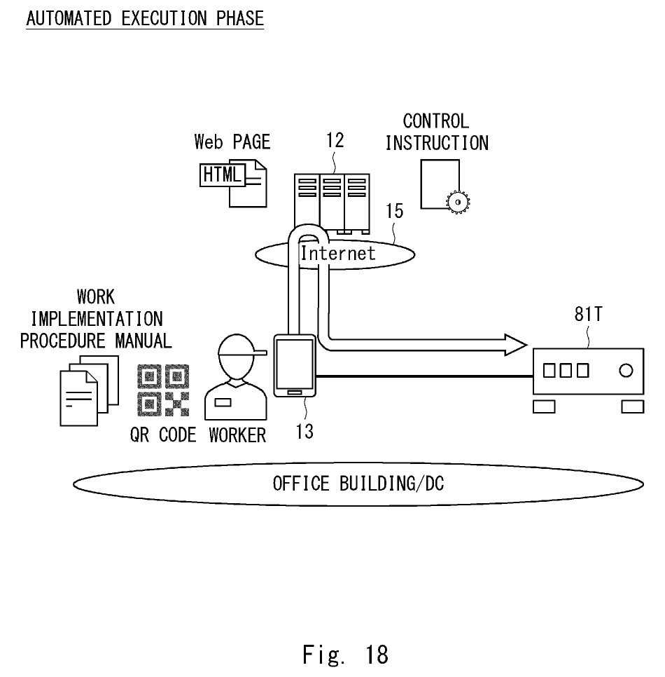

The operation of the third example embodiment is roughly divided into two phases: a preliminary preparation phase illustrated in FIG. 3 and an automated execution phase illustrated in FIG. 18.

First, an operation of the preliminary preparation phase will be described.

As illustrated in FIG. 3, in the preliminary preparation phase, a work plan manager who is a manager of the maintenance and operation work first inputs work information including a type of maintenance and operation work and work parameters that are parameters necessary for the maintenance and operation work to a command generator 11.

The command generator 11 generates a control instruction, a web page, and a QR code suitable for the input maintenance and operation work based on the input work information. These products are output for each NW device that is a control target. Hereinafter, it is assumed that the control target NW device is the NW device 81T.

The control instruction is an electronic file including commands input to the NW device 81T according to the work procedure of the input maintenance and operation work and information regarding an input order of the commands. The web page is a web page for downloading the control instruction. The QR code is a two-dimensional code in which a character string of a URL for uniquely accessing the web page is encoded.

Before a worker enters a building such as an office building or a DC where the NW device 81T is installed (alternatively, the NW device 81T is newly installed) and starts work, the control instruction and the web page are stored in the server 12 on the Internet 15, and the QR code is transmitted to the worker who enters the work location. The QR code may be an electronic image or a printed matter, but in FIG. 3, it is assumed that the QR code is printed in a paper work implementation procedure manual carried by the worker.

Next, an operation of the automated execution phase will be described.

FIG. 18 is a diagram illustrating an operation example of the automated execution phase according to the present disclosure.

As illustrated in FIG. 18, in the automated execution phase, actual work of the maintenance and operation work to which the present disclosure is applied is performed.

First, the worker carrying the work implementation procedure manual on which the QR code is printed and the smart device 13 enters a building such as an office building or a DC in which the NW device 81T is installed (alternatively, the NW device 81T is newly installed).

Next, the worker directly connects the NW device 81T to the smart device 13 according to a procedure of the work implementation procedure manual. Accordingly, the NW device 81T can access the Internet 15 via the smart device 13.

Further, the worker advances the maintenance and operation work according to the procedure of the work implementation procedure manual. During the procedure, in the work of reading the QR code, the worker reads the QR code printed in the work implementation procedure manual by using the camera function of the smart device 13. Then, the URL is displayed on a screen of the smart device 13. If the worker touches the URL, a browser of the smart device 13 is started, the server 12 on the Internet 15 is automatically accessed, and a web page is displayed on the screen of the smart device 13.

If the worker checks on the browser that “the control instruction is downloaded and the commands are automatically input to the NW device” and presses an execution button in the web page, the control instruction is downloaded to the smart device 13. Thereafter, the smart device 13 sequentially inputs the commands to the NW device 81T according to the content of the control instruction. That is, the smart device 13 inputs the commands included in the control instruction to the NW device 81T according to the information regarding the input order included in the control instruction. Accordingly, the maintenance and operation work is completed.

Hereinafter, the third example embodiment will be described in detail.

### Details of Third Example Embodiment

First, a configuration of the third example embodiment will be described.

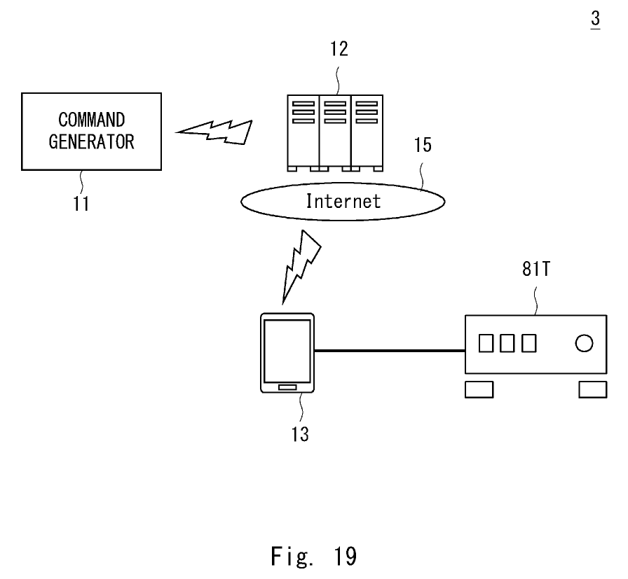

FIG. 19 is a diagram illustrating a configuration example of a maintenance and operation system 3 according to the present disclosure.

As illustrated in FIG. 19, the maintenance and operation system 3 includes a command generator 11, a server 12, and a smart device 13.

Hereinafter, individual constituent elements included in the maintenance and operation system 3 will be described.

First, the command generator 11 will be described.

As illustrated in FIG. 6, the work parameters necessary for the maintenance and operation work are set for each type of maintenance and operation work. Therefore, in a case where the work information is input to the command generator 11, the work plan manager first inputs the type of maintenance and operation work, and then inputs the work parameters necessary for the maintenance and operation work. For example, in a case where “new installation of NW device” is input as the type of maintenance and operation work, the work plan manager inputs “installation location”, “mounting position”, “device product name”, “manufacturing vendor”, “device name”, “IP address”, and “Config file” as the work parameters. As a method of inputting the work information, there is a method of inputting the work information to the command generator 11 using a GUI. As another method, there is a method of describing a plurality of types of maintenance and operation work and work parameters of each of the plurality of types of maintenance and operation work in an electronic file in a CSV format and importing the electronic file into the command generator 11.

Based on the input work information, the command generator 11 generates and outputs three items: a control instruction including commands according to the work procedure of the input maintenance and operation work and information regarding an input order of the commands, a web page for downloading the control instruction, and a QR code obtained by encoding a character string of a URL for uniquely accessing the web page.

The control instruction and the web page generated by the command generator 11 are stored in the server 12 on the Internet 15. It is assumed that the control instruction and the web page are directly output from the command generator 11 to the server 12 by a wireless or wired communication function. However, the present disclosure is not limited thereto, and the control instruction and the web page may be output to a separate device and may be output from the separate device to the server 12.

On the other hand, the QR code generated by the command generator 11 is transmitted to a worker who enters a work location. For example, the QR code is printed on a paper work implementation procedure manual brought by the worker in FIG. 3.

As illustrated in FIG. 7, in the work implementation procedure manual, work content performed by the worker on the day of work is described in order of work. In the example of FIG. 7, the QR code output from the command generator 11 is attached to a supplementary field next to work content of No. 11. In FIG. 3, the work implementation procedure manual is paper, but may be an electronic file.

Next, the server 12 will be described.

The server 12 is a server provided on the Internet 15, and has a function of storing the control instruction and the web page output from the command generator 11. The server 12 has a function of transferring the control instruction to the smart device 13. For example, in a case where the worker presses an execution button in a web page displayed on the screen of the smart device 13, the server 12 transfers a control instruction to the smart device 13.

Next, the smart device 13 will be described.

The smart device 13 is a general-purpose product such as a smartphone or a tablet that is carried and held by a worker for contact with a person concerned.

The smart device 13 normally has a wireless connection function of accessing the Internet 15 via a 4G/5G line or WiFi.

The smart device 13 is connected to the NW device 81T, and inputs a command to the NW device 81T according to the control instruction. For example, the smart device 13 may incorporate general-purpose software having a function of sequentially inputting commands based on the content of the control instruction.

Here, a connection protocol between the smart device 13 and the NW device 81T, the commands input to the NW device 81T, and an input order of the commands are different depending on specifications of a vendor and a product. However, these differences are all absorbed in the control instruction.

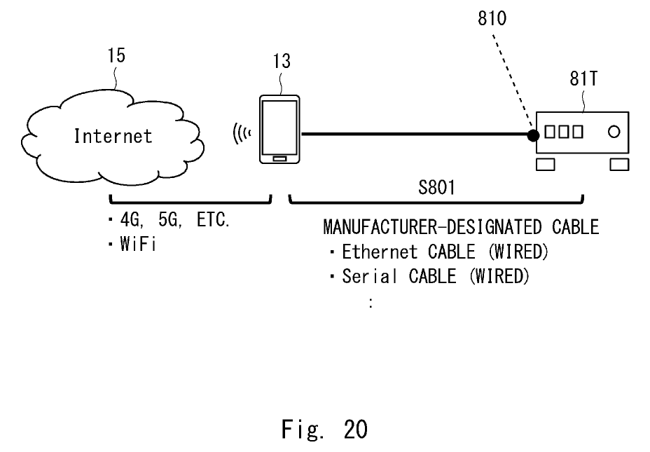

FIG. 20 is a diagram illustrating an example of a method of connecting the smart device 13 according to the present disclosure.

As illustrated in FIG. 20, in step S801, the NW device 81T and the smart device 13 are connected. For example, the smart device 13 is physically connected to the management port 810 that controls the NW device 81T by a cable (such as an Ethernet cable or a serial cable) designated by a manufacturer of the NW device 81T. If the connection in step S801 is completed, the NW device 81T can access the Internet 15 via the smart device 13.

The smart device 13 typically has a camera function. A worker uses the camera function to read a QR code attached to a work implementation procedure manual. If the QR code is read, the URL is displayed on the screen. If the worker touches the URL, the browser is started, the server 12 on the Internet 15 is accessed and a web page is displayed on the screen. If the worker presses the execution button in the web page, the control instruction is downloaded to the smart device 13.

Next, an operation of the third example embodiment will be described.

First, an operation of the preliminary preparation phase will be described.

As illustrated in FIG. 3, the work plan manager first inputs work information including a type of maintenance and operation work and work parameters necessary for the maintenance and operation work to the command generator 11. Then, the command generator 11 generates a control instruction, a web page, and a QR code based on the input work information.

Here, an operation of the command generator 11 will be described in detail.

As illustrated in FIG. 9, the command generator 11 generates a web page and a control instruction by performing conversion in steps S401, S402, and S403 on the input work information. At this time, the command generator 11 generates a web page dedicated to the NW device 81T based on the information of the type of the maintenance and operation work, an installation location, and a mounting position delivered as the work information. The command generator 11 generates a control instruction dedicated to the NW device 81T in which character strings of unique commands based on the specifications of the device product are arranged in a unique input order based on the information regarding a device product name, a manufacturing vendor, a device name, an IP address, and a Config file delivered as the work information.

The command generator 11 generates a QR code by encoding a character string of a URL for uniquely accessing the web page.

The control instruction and the web page generated by the command generator 11 are stored in the server 12 on the Internet 15. The QR code generated by the command generator 11 is transmitted to the worker. For example, the QR code is printed in the supplementary field next to relevant work content in the paper work implementation procedure manual carried by the worker.

Next, an operation of the automated execution phase will be described.

As illustrated in FIG. 18, the worker carrying the work implementation procedure manual and the smart device 13 first enters a building such as an office building or a DC in which the NW device 81T is installed (alternatively, the NW device 81T is newly installed).

Next, the worker performs connection work for connecting the NW device 81T and the smart device 13. If the connection work is completed, the NW device 81T can access the Internet 15 via the smart device 13.

Subsequent operations will be described by taking, as an example, the work of installing the new NW device 81T along the work implementation procedure manual illustrated in FIG. 7 and FIG. 10.

Here, as described above, the worker has completed the connection work for connecting the NW device 81T to the smart device 13. Therefore, it is assumed that the procedures until the work content of No. 10 in FIG. 7 are completed.

Next, the worker reads the QR code attached to the supplementary field using the camera function of the smart device 13 (a tablet in FIG. 7) according to work content of No. 11 in FIG. 7. Then, the URL is displayed on the screen of the smart device 13 (step S501 in FIG. 10).

Next, the worker touches the URL displayed on the screen of the smart device 13 according to the work content of No. 12 in FIG. 7. Then, the browser of the smart device 13 is started, the server 12 on the Internet 15 is accessed, and a web page is displayed on the screen of the smart device 13 (step S502 in FIG. 10). At this time, since the above read QR code is obtained by encoding the character string of the URL for uniquely accessing the web page dedicated to the NW device 81T, the web page displayed in step S502 of FIG. 10 is the web page dedicated to the NW device 81T. Therefore, a sentence (in the example of FIG. 10, "Initial file for Yokohama Bureau Rack: 3 Shelf: 2 is installed”) dedicated to the NW device 81T is displayed on the web page dedicated to the NW device 81T.

Next, the worker checks that the sentence described in the supplementary field on the side is displayed on the screen of the smart device 13 according to the work content of No. 13 in FIG. 7. Accordingly, the worker can check that a correct process is performed for the NW device (the NW device 81T) described in the work content of No. 9 in FIG. 7.

Next, the worker presses the execution button in the web page displayed in step S502 in FIG. 10 according to the work content of No. 14 in FIG. 7. Then, subsequent command input work to the NW device 81T is automatically executed without the worker being involved at all.

In practice, if the execution button in the web page displayed on the screen of the smart device 13 is pressed, a process associated with the execution button, that is, a process of transferring the control instruction from the server 12 to the smart device 13 is started. If the control instruction is received from the server 12, the smart device 13 sequentially and automatically inputs the commands to the NW device 81T according to the content of the control instruction. A progress status of the automatic input of the commands from the smart device 13 is displayed in real time in a web page on the screen of the smart device 13 (step S503 in FIG. 10). Therefore, the worker can know the progress status and completion of the automatic input of the commands. In this way, all the control of the maintenance and operation work on the NW device 81T can be automated.

As described above, according to the third example embodiment, the work information including the type of maintenance and operation work and the work parameters necessary for the maintenance and operation work is input to the command generator 11. Based on the input work information, the command generator 11 generates the control instruction including the commands to be input to the control target NW device 81T and the information regarding the input order of the commands, the web page for downloading the control instruction, and the QR code obtained by encoding a character string of a URL for accessing the web page. The control instruction and the web page are stored in the server 12 on the Internet 15, and the QR code is attached to the work implementation procedure manual. The smart device 13 is connected to the NW device 81T and enables access from the NW device 81T to the Internet 15. If the QR code attached to the work implementation procedure manual is read by the worker using the camera function of the smart device 13, the URL is displayed on the screen. If the worker touches the URL, the smart device 13 accesses the server 12 and displays a web page on the screen. If the worker presses the execution button in the web page, the control instruction is downloaded from the server 12 to the smart device 13. The smart device 13 sequentially inputs the commands to the NW device 81T according to the control instruction.

Therefore, according to the third example embodiment, it is possible to perform the maintenance and operation work on the NW device 81T without connecting the control target NW device 81T to the DCN 83. In an environment where the smart device 13 can access the Internet 15, the maintenance and operation work for the NW device 81T can be executed. Therefore, it is possible to relax restriction of the work location where the maintenance and operation work is performed.

According to the third example embodiment, it is possible to obtain the same effects (the other effects 1 to 8 described above) as those of the first example embodiment described above.

### Fourth Example Embodiment

### Image of Fourth Example Embodiment

First, an image of a fourth example embodiment will be described.

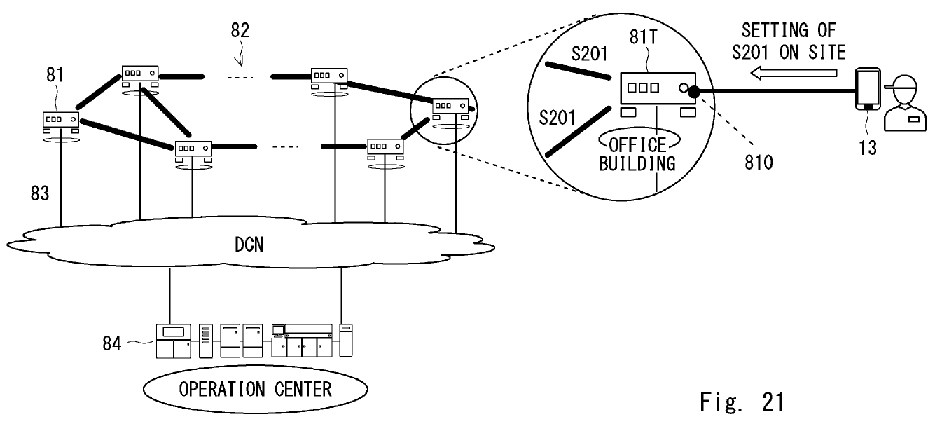

FIG. 21 is a diagram illustrating an image example of maintenance and operation work for an NW device according to the present disclosure. In FIG. 21, similarly to FIG. 1, it is assumed that maintenance and operation work of adding a new NW device 81T to the service NW 82 is performed. In FIG. 21, similarly to FIG. 1, it is assumed that the plurality of NW devices 81 forming the service NW 82 are connected to the DCN 83, and the control monitoring system 84 is connected to the DCN 83.

As illustrated in FIG. 21, in the present disclosure, the smart device 13 has a mechanism holding a control instruction for incorporating the NW device 81T into the service NW 82.

That is, in the present disclosure, the worker carrying the smart device 13 that holds the control instruction enters the office building. Then, setting (S201) for incorporating the NW device 81T into the service NW 82 is performed. Therefore, it is possible to perform maintenance and operation work on the NW device 81T in a state where the NW device 81T is not connected to the DCN 83.

### Outline of Fourth Example Embodiment

Next, an outline of the fourth example embodiment will be described.

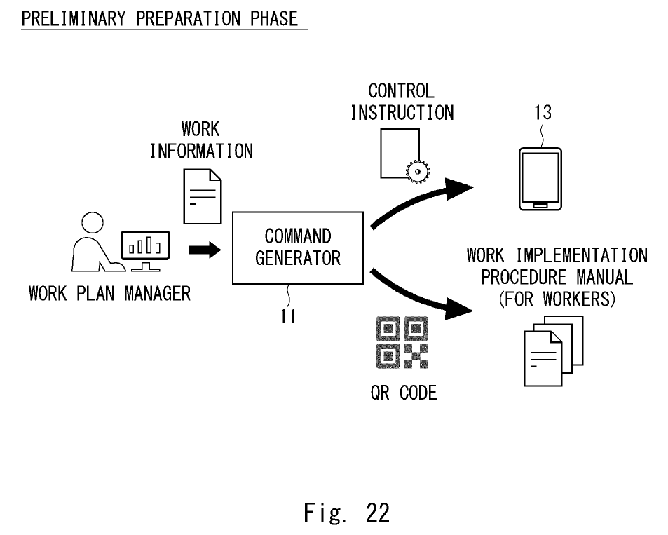

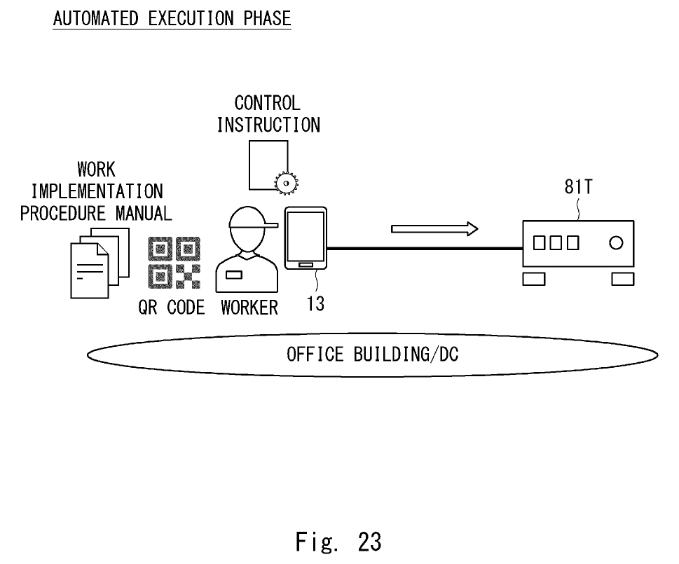

The operation of the fourth example embodiment is roughly divided into two phases: a preliminary preparation phase illustrated in FIG. 22 and an automated execution phase illustrated in FIG. 23.

First, an operation of the preliminary preparation phase will be described.

FIG. 22 is a diagram illustrating an operation example of the preliminary preparation phase according to the present disclosure.

As illustrated in FIG. 22, in the preliminary preparation phase, the work plan manager who is the manager of the maintenance and operation work first inputs work information including the type of maintenance and operation work and work parameters which are parameters necessary for the maintenance and operation work to the command generator 11.

The command generator 11 generates a control instruction and a QR code suitable for the input maintenance and operation work based on the input work information. These products are output for each NW device that is a control target. Hereinafter, it is assumed that the control target NW device is the NW device 81T.

The control instruction is an electronic file including commands input to the NW device 81T according to the work procedure of the input maintenance and operation work and information regarding an input order of the commands. The QR code is a two-dimensional code for starting an application necessary for executing the control instruction.

Before a worker enters a building such as an office building or a DC where the NW device 81T is installed (alternatively, the NW device 81T is newly installed) and starts work, the control instruction is stored in the smart device 13, and the QR code is transmitted to the worker who enters the work location. The QR code may be an electronic image or a printed matter, but in FIG. 22, it is assumed that the QR code is printed in a paper work implementation procedure manual carried by the worker.

Next, an operation of the automated execution phase will be described.

FIG. 23 is a diagram illustrating an operation example of the automated execution phase according to the present disclosure.

As illustrated in FIG. 23, in the automated execution phase, actual work of the maintenance and operation work to which the present disclosure is applied is performed.

First, the worker carrying the work implementation procedure manual on which the QR code is printed and the smart device 13 enters a building such as an office building or a DC in which the NW device 81T is installed (alternatively, the NW device 81T is newly installed).

Next, the worker directly connects the NW device 81T to the smart device 13 according to a procedure of the work implementation procedure manual. Accordingly, the NW device 81T can access the smart device 13.

Further, the worker advances the maintenance and operation work according to the procedure of the work implementation procedure manual. During the procedure, in the work of reading the QR code, the worker reads the QR code printed in the work implementation procedure manual by using the camera function of the smart device 13. Then, the application is started on the screen of the smart device 13.

If the worker checks on the application screen that “the commands are automatically input to the NW device” and presses an execution button on the application screen, the smart device 13 sequentially inputs the commands to the NW device 81T according to the content of the control instruction. That is, the smart device 13 inputs the commands included in the control instruction to the NW device 81T according to the information regarding the input order included in the control instruction. Accordingly, the maintenance and operation work is completed.

Hereinafter, the fourth example embodiment will be described in detail.

### Details of Fourth Example Embodiment

First, a configuration of the fourth example embodiment will be described.

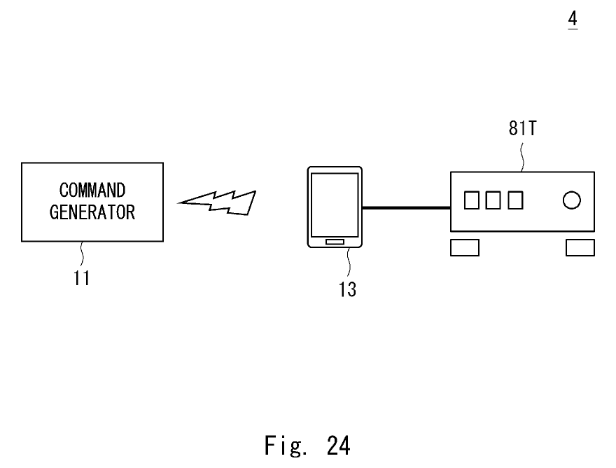

FIG. 24 is a diagram illustrating a configuration example of a maintenance and operation system 4 according to the present disclosure.

As illustrated in FIG. 24, the maintenance and operation system 4 includes a command generator 11 and a smart device 13.

Hereinafter, individual constituent elements included in the maintenance and operation system 4 will be described.

First, the command generator 11 will be described.

As illustrated in FIG. 6, the work parameters necessary for the maintenance and operation work are set for each type of maintenance and operation work. Therefore, in a case where the work information is input to the command generator 11, the work plan manager first inputs the type of maintenance and operation work, and then inputs the work parameters necessary for the maintenance and operation work. For example, in a case where “new installation of NW device” is input as the type of maintenance and operation work, the work plan manager inputs “installation location”, “mounting position”, “device product name”, “manufacturing vendor”, “device name”, “IP address”, and “Config file” as the work parameters. As a method of inputting the work information, there is a method of inputting the work information to the command generator 11 using a GUI. As another method, there is a method of describing a plurality of types of maintenance and operation work and work parameters of each of the plurality of types of maintenance and operation work in an electronic file in a CSV format and importing the electronic file into the command generator 11.

Based on the input work information, the command generator 11 generates and outputs two items: a control instruction including commands according to the work procedure of the input maintenance and operation work and information regarding the input order of the commands and a QR code for starting an application necessary for executing the control instruction.

The control instruction generated by the command generator 11 is stored in the smart device 13. It is assumed that the control instruction is directly output from the command generator 11 to the smart device 13 by a wireless or wired communication function. However, the present disclosure is not limited thereto, and the control instruction may be output to a separate device and output from the separate device to the smart device 13.

On the other hand, the QR code generated by the command generator 11 is transmitted to a worker who enters a work location. For example, the QR code is printed in a paper work implementation procedure manual brought by the worker in FIG. 22.

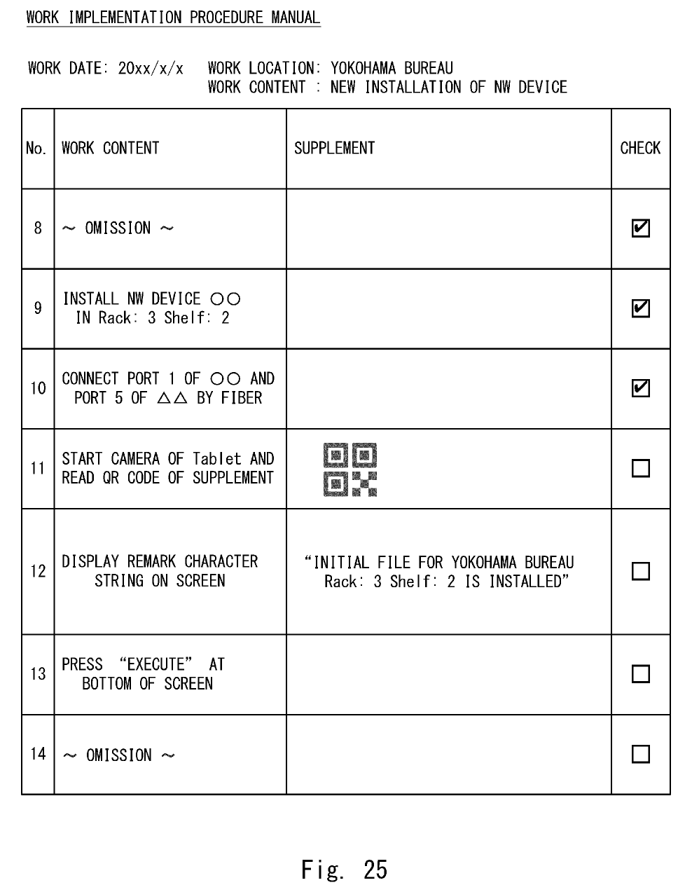

FIG. 25 is a diagram illustrating an example of a work implementation procedure manual according to the present disclosure.

As illustrated in FIG. 25, in the work implementation procedure manual, work content performed by the worker on the day of work is described in order of work. In the example of FIG. 25, the QR code output from the command generator 11 is attached to the supplementary field next to the work content of No. 11. In FIG. 22, the work implementation procedure manual is paper, but may be an electronic file.

Next, the smart device 13 will be described.

The smart device 13 is a general-purpose product such as a smartphone or a tablet that is carried and held by a worker for contact with a person concerned.

The smart device 13 stores a control instruction, and inputs the commands to the NW device 81T according to the control instruction. For example, the smart device 13 may incorporate general-purpose software having a function of sequentially inputting commands based on the content of the control instruction.

Here, a connection protocol between the smart device 13 and the NW device 81T, the commands input to the NW device 81T, and an input order of the commands are different depending on specifications of a vendor and a product. However, these differences are all absorbed in the control instruction.

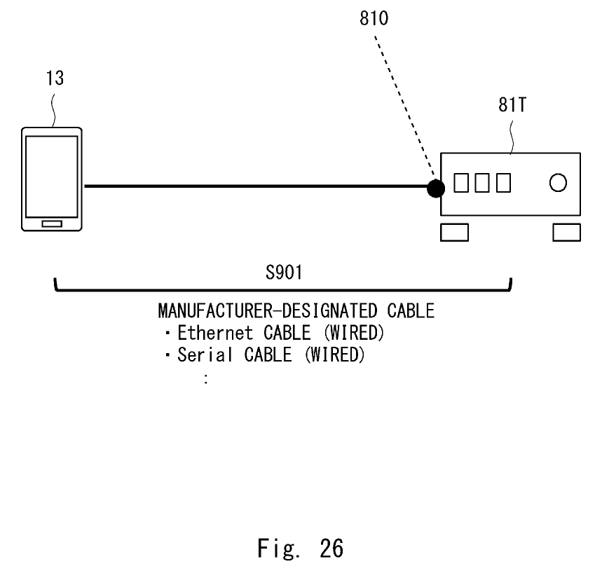

FIG. 26 is a diagram illustrating an example of a method of connecting the smart device 13 according to the present disclosure.

As illustrated in FIG. 26, in step S901, the NW device 81T and the smart device 13 are connected. For example, the smart device 13 is physically connected to the management port 810 that controls the NW device 81T by a cable (such as an Ethernet cable or a serial cable) designated by a manufacturer of the NW device 81T.

The smart device 13 typically has a camera function. A worker uses the camera function to read a QR code attached to a work implementation procedure manual. If the QR code is read, the application is started and an application screen is displayed. If the worker presses the execution button on the application screen, the smart device 13 sequentially inputs the commands to the NW device 81T according to the content of the control instruction.

Next, an operation of the fourth example embodiment will be described.

First, an operation of the preliminary preparation phase will be described.

As illustrated in FIG. 22, the work plan manager first inputs work information including a type of maintenance and operation work and work parameters necessary for the maintenance and operation work to the command generator 11. Then, the command generator 11 generates a control instruction and a QR code based on the input work information.

Here, an operation of the command generator 11 will be described in detail.

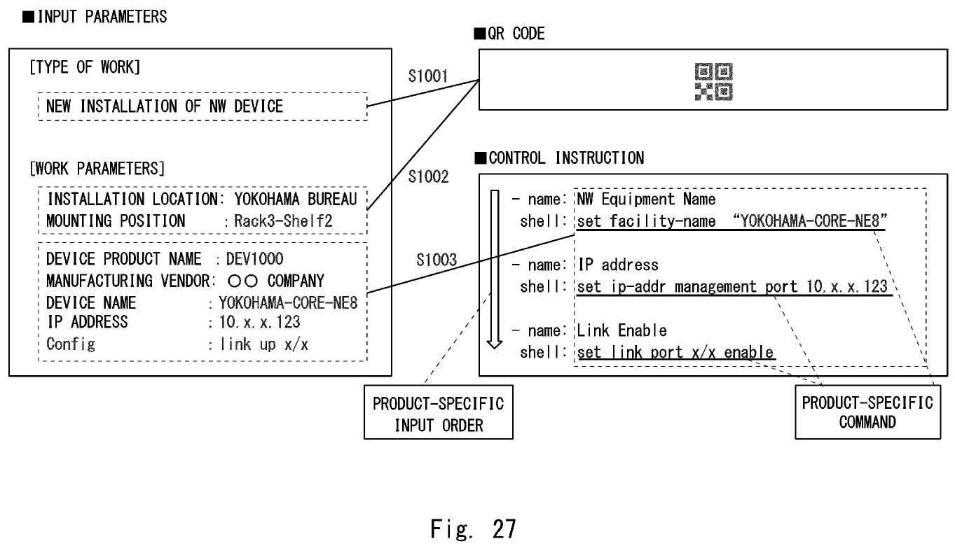

FIG. 27 is a diagram illustrating an operation example of the command generator 11 according to the present disclosure.

As illustrated in FIG. 27, the command generator 11 generates a QR code and a control instruction by performing conversion in steps S1001, S1002, and S1003 on the input work information. At this time, the command generator 11 determines an application to be started based on the information regarding the type of the maintenance and operation work, the installation location, and the mounting position delivered as the work information, and generates a QR code dedicated to the NW device 81T as a code for starting the determined application. The command generator 11 generates a control instruction dedicated to the NW device 81T in which character strings of unique commands based on the specifications of the device product are arranged in a unique input order based on the information regarding a device product name, a manufacturing vendor, a device name, an IP address, and a Config file delivered as the work information.

The control instruction generated by the command generator 11 is stored in the smart device 13. The QR code generated by the command generator 11 is transmitted to the worker. For example, the QR code is printed in the supplementary field next to relevant work content in the paper work implementation procedure manual carried by the worker.

Next, an operation of the automated execution phase will be described.

As illustrated in FIG. 23, the worker carrying the work implementation procedure manual and the smart device 13 first enters a building such as an office building or a DC in which the NW device 81T is installed (alternatively, the NW device 81T is newly installed).

Next, the worker performs connection work for connecting the NW device 81T and the smart device 13. If the connection work is completed, the smart device 13 can access the NW device 81T.

Subsequent operations will be described by taking, as an example, work of installing a new NW device 81T according to the work implementation procedure manual illustrated in FIG. 25.

Here, as described above, the worker has completed the connection work for connecting the NW device 81T to the smart device 13. Therefore, it is assumed that the procedures until the work content of No. 10 in FIG. 25 have been completed.

Next, the worker reads the QR code attached to the supplementary field by the camera function of the smart device 13(a tablet in FIG. 25) according to the work content of No. 11 in FIG. 25. Then, the application is started on the screen of the smart device 13. This web page is dedicated to the NW device 81T. In the QR code read at this time, the type of maintenance and operation work, the installation location, and the mounting position are dedicated to the NW device 81T. Therefore, a sentence (in the example of FIG. 25, “Initial file for Yokohama Bureau Rack: 3 Shelf: 2 is installed”) dedicated to the NW device 81T is displayed on the application screen.

Next, the worker checks that the sentence described in the supplementary field on the side is displayed on the application screen of the smart device 13 according to the work content of No. 12 in FIG. 25. Accordingly, the worker can check that the correct process is performed for the NW device (NW device 81T) described in the work content of No. 9 in FIG. 25.

Next, the worker presses an execution button (relevant to the execution button in the web page displayed in step S502 in FIG. 10) on the application screen according to the work content of No. 13 in FIG. 25. Then, subsequent command input work to the NW device 81T is automatically executed without the worker being involved at all.

In practice, if the execution button on the application screen of the smart device 13 is pressed, a process associated with the execution button, that is, a process in which the smart device 13 sequentially and automatically inputs the commands to the NW device 81T according to the content of the control instruction is started. A progress status of the automatic input of the commands from the smart device 13 is displayed on the application screen of the smart device 13 (relevant to the screen of the web page displayed in step S503 in FIG. 10) in real time. Therefore, the worker can know the progress status and completion of the automatic input of the commands. In this way, all the control of the maintenance and operation work on the NW device 81T can be automated.

As described above, according to the fourth example embodiment, the work information including the type of maintenance and operation work and the work parameters necessary for the maintenance and operation work is input to the command generator 11. Based on the input work information, the command generator 11 generates the control instruction including the commands to be input to the control target NW device 81T and the information regarding the input order of the commands, and the QR code for starting an application necessary for executing the control instruction. The control instruction is stored in the smart device 13, and the QR code is attached to the work implementation procedure manual. The smart device 13 is connected to the NW device 81. If the QR code attached to the work implementation procedure manual is read by the worker using the camera function of the smart device 13, the application is started on the screen of the smart device 13. If the worker presses the execution button on the application screen, the smart device 13 sequentially inputs the commands to the NW device 81T according to the control instruction.

Therefore, according to the fourth example embodiment, it is possible to perform the maintenance and operation work on the NW device 81T without connecting the control target NW device 81T to the DCN 83.

According to the fourth example embodiment, it is possible to obtain effects similar to those of the first example embodiment described above (the other effects 1 to 8 described above).

### Maintenance and Operation Work of First to Fourth Example Embodiments

In the above-described first to fourth example embodiments, as the maintenance and operation work, the work of adding the new NW device 81T has been mainly described as an example, but other types of maintenance and operation work can be handled according to a similar method. Hereinafter, examples of other maintenance and operation work will be described.

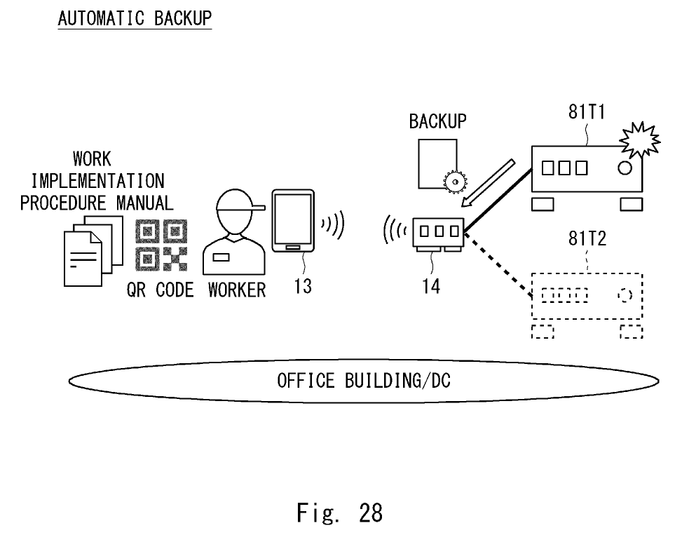

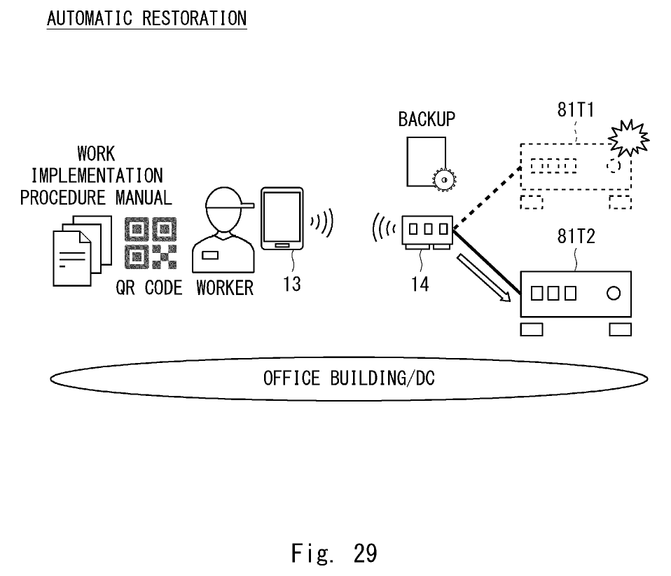

FIG. 28 is a diagram illustrating an operation example in a case where backup work is performed on an NW device 81T1 according to the present disclosure. FIG. 29 is a diagram illustrating an operation example in a case where restoration work is performed on an NW device 81T2 according to the present disclosure. In FIGS. 28 and 29, it is assumed that the backup work and the restoration work are implemented by any of the maintenance and operation systems 1 and 2.

As illustrated in FIG. 28, in a case where the NW device 81T1 fails, data of the NW device 81T1 is stored as backup data in the control adapter 14. As illustrated in FIG. 29, in a case where exchange from the failed NW device 81T1 to the NW device 81T2 is completed, the backup data stored in the control adapter 14 is transmitted to the NW device 81T2 to restore the NW device 81T2. Therefore, even if the control target NW devices 81T1 and 81T2 are not connected to the DCN 83, the backup work and the restoration work can be performed as the maintenance and operation work.

In FIGS. 28 and 29, the backup data is stored in the control adapter 14, but the present disclosure is not limited thereto. The backup data may be stored in the smart device 13. In this case, the backup work and the restoration work illustrated in FIGS. 28 and 29 can be achieved by any of the maintenance and operation systems 1 to 4.

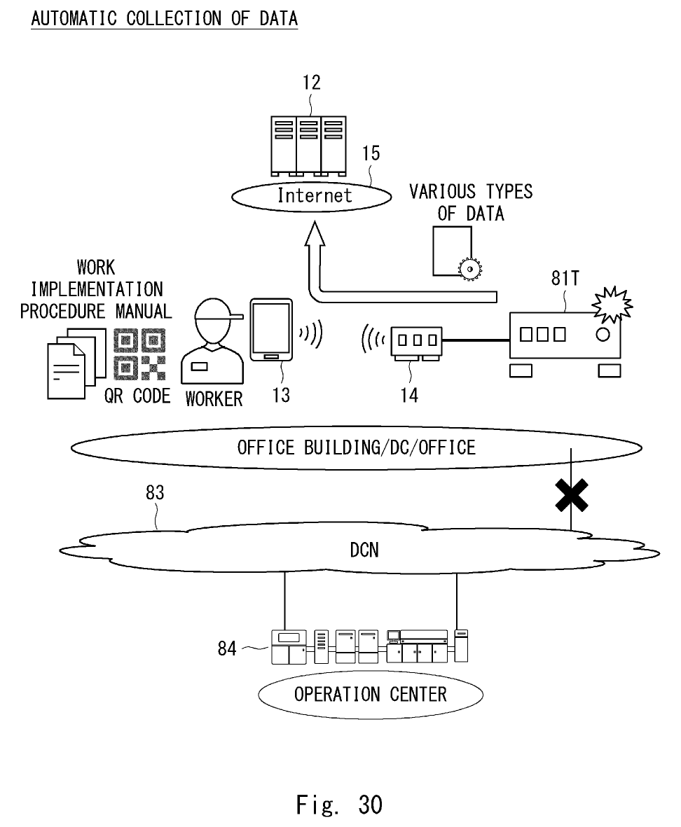

FIG. 30 is a diagram illustrating an operation example in a case where data collection work is performed on the NW device 81T according to the present disclosure. In FIG. 30, it is assumed that the data collection work is achieved by the maintenance and operation system 1.

As illustrated in FIG. 30, the server 12 on the Internet 15 collects data from the NW device 81T via the control adapter 14 and the smart device 13. Therefore, the data collection work can be performed as the maintenance and operation work without connecting the control target NW device 81T to the DCN 83.

In FIG. 30, the server 12 collects data from the NW device 81T via the control adapter 14 and the smart device 13, but the present disclosure is not limited thereto. The server 12 may collect data via the smart device 13. In this case, the data collection work illustrated in FIG. 30 can be achieved by any of the maintenance and operation systems 1 and 3.

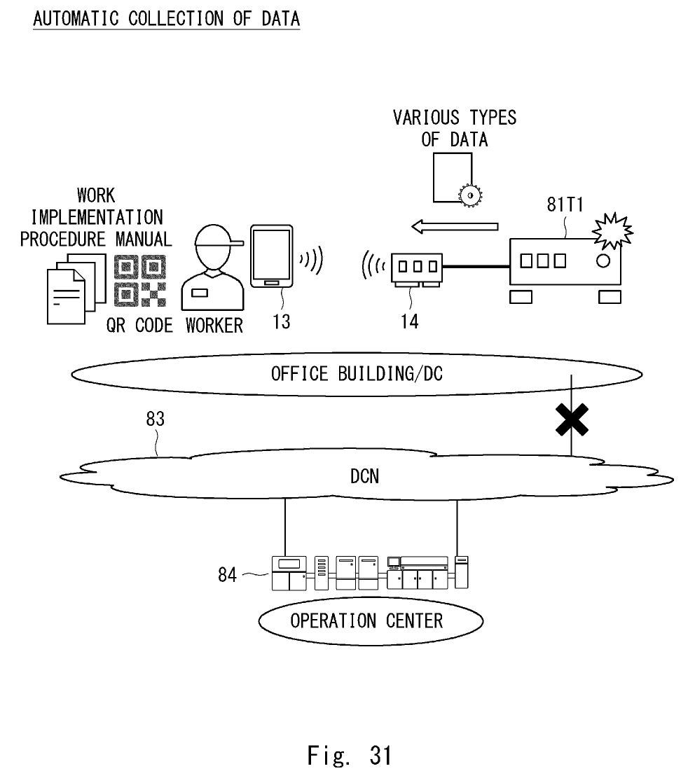

FIG. 31 is a diagram illustrating an operation example in a case where data collection work is performed on the NW device 81T according to the present disclosure. In FIG. 31, it is assumed that the data collection work is achieved by any of the maintenance and operation systems 1 and 2.

As illustrated in FIG. 31, the control adapter 14 collects data from the NW device 81T. Therefore, the data collection work can be performed as the maintenance and operation work without connecting the control target NW device 81T to the DCN 83.

In FIG. 31, the control adapter 14 collects data from the NW device 81T, but the present disclosure is not limited thereto. The smart device 13 may collect data directly from the NW device 81T. In this case, the data collection work illustrated in FIG. 31 can be achieved by any of the maintenance and operation systems 1 to 4.

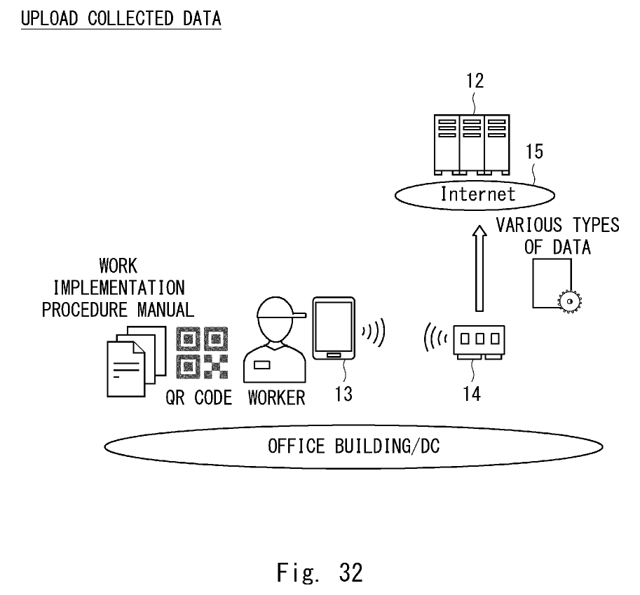

FIG. 32 is a diagram illustrating an operation example in a case where data uploading work is performed on the NW device 81T according to the present disclosure. In FIG. 31, it is assumed that data uploading work is achieved by the maintenance and operation system 1. It is assumed that collection of data from the NW device 81T by the control adapter 14 is completed.

As illustrated in FIG. 32, the control adapter 14 uploads the collected data from the NW device 81T to the server 12 on the Internet 15. Therefore, the data uploading work can be performed as the maintenance and operation work without connecting the control target NW device 81T to the DCN 83.

In FIG. 32, the control adapter 14 uploads the collected data from the NW device 81T to the server 12, but the present disclosure is not limited thereto. The smart device 13 may upload the collected data directly from the NW device 81T or via the control adapter 14 to the server 12. In this case, the data uploading work illustrated in FIG. 32 can be achieved by any of the maintenance and operation systems 1 and 3.

### Fifth Example Embodiment

A fifth example embodiment is relevant to a superordinate example embodiment of the first to fourth example embodiments described above.

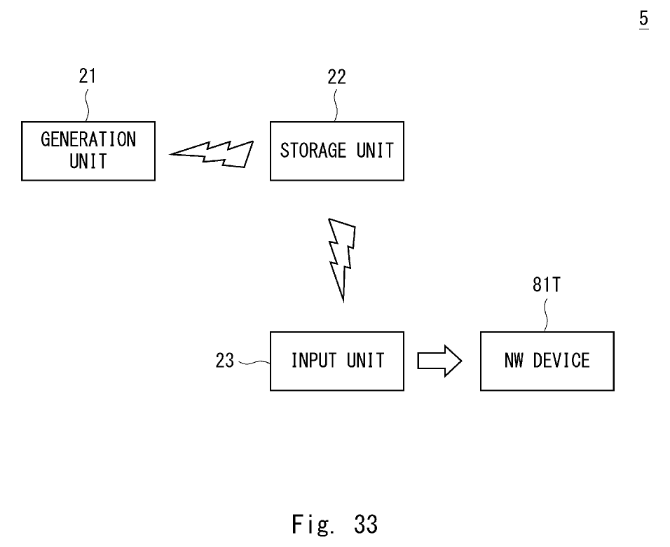

FIG. 33 is a diagram illustrating a configuration example of a maintenance and operation system 5 according to the present disclosure.

As illustrated in FIG. 33, the maintenance and operation system 5 includes a generation unit 21, a storage unit 22, and an input unit 23.

The generation unit 21 receives an input of work information including a type of maintenance and operation work and work parameters necessary for the maintenance and operation work. Then, the generation unit 21 generates a control instruction including commands to be input to the control target NW device and information regarding an input order of the commands based on the work information.

The storage unit 22 stores a control instruction.

The input unit 23 inputs the commands to the control target NW device in the input order of the commands based on the control instruction.

Therefore, according to the fifth example embodiment, it is possible to perform maintenance and operation work on the control target NW device without connecting the control target NW device to the DCN 83.

The maintenance and operation system 5 may further include a smart device. In this case, the storage unit 22 may be a server on the Internet. The input unit 23 may be a control adapter that is connected to the smart device in a wireless or wired manner and is connected to the control target NW device in a wired manner. The generation unit 21 may further generate a web page for downloading the control instruction. The server may further store the web page. The smart device may access the server on the Internet using a wireless connection function to display the web page on a screen. If a specific button in the web page displayed on the screen of the smart device is pressed, the server may transfer the control instruction to the control adapter via the smart device. The control adapter may input the commands to the control target NW device in the input order of the commands based on the control instruction. The generation unit 21 may further generate a two-dimensional code in which a URL for accessing a web page is encoded. The smart device may display the URL on the screen if the two-dimensional code is read using the camera function, and may access a server on the Internet using the wireless connection function to display a web page on the screen if the URL is touched. The control adapter may be portable.

The maintenance and operation system 5 may further include a smart device. In this case, the storage unit 22 and the input unit 23 may be a control adapter connected to the smart device in a wireless or wired manner and connected to the control target NW device in a wired manner. The generation unit 21 may further generate a web page for executing the control instruction. The control adapter may further store a web page. The smart device may access the control adapter using the wireless connection function to display a web page on the screen. If a specific button in the web page displayed on the screen of the smart device is pressed, the control adapter may input the commands to the control target NW device in the input order of the commands based on the control instruction. The generation unit 21 may further generate a two-dimensional code in which a URL for accessing a web page is encoded. The smart device may display the URL on the screen if the two-dimensional code is read using the camera function, and may access the control adapter using the wireless connection function to display the web page on the screen if the URL is touched. The control adapter may be portable.

Alternatively, the storage unit 22 may be a server on the Internet. The input unit 23 may be a smart device connected to the control target NW device in a wired manner. The generation unit 21 may further generate a web page for downloading the control instruction. The server may further store the web page. The smart device may access the server on the Internet using a wireless connection function to display the web page on a screen. If a specific button in the web page displayed on the screen of the smart device is pressed, the server may transfer the control instruction to the smart device. The smart device may input the commands to the control target NW device in the input order of the commands based on the control instruction. The generation unit 21 may further generate a two-dimensional code in which a URL for accessing a web page is encoded. The smart device may display the URL on the screen if the two-dimensional code is read using the camera function, and may access a server on the Internet using the wireless connection function to display a web page on the screen if the URL is touched.

Alternatively, the storage unit 22 and the input unit 23 may be smart devices connected to the control target NW device in a wired manner. The generation unit 21 may further generate a two-dimensional code for starting an application necessary for executing the control instruction. If the two-dimensional code is read using the camera function, the smart device may start the application. If a specific button on the application screen is pressed, the smart device may input the commands to the control target NW device in the input order of the commands based on the control instruction.

The two-dimensional code may be attached to a work implementation procedure manual defining a procedure of maintenance and operation work.

The work implementation procedure manual may be paper. In this case, the two-dimensional code may be attached to the work implementation procedure manual as a printed matter.

Alternatively, the work implementation procedure manual may be an electronic file. In this case, the two-dimensional code may be attached as an electronic image to the work implementation procedure manual.

However, a configuration of the present disclosure is not limited thereto. The present disclosure may be configured to include: a reception unit that receives an input of work information including a type of maintenance and operation work and work parameters necessary for the maintenance and operation work; and a generation unit that generates a control instruction including commands to be input to a control target network device and information regarding an input order of the commands based on the work information.

<Hardware Configuration of Constituent Elements Included in Maintenance and Operation System>

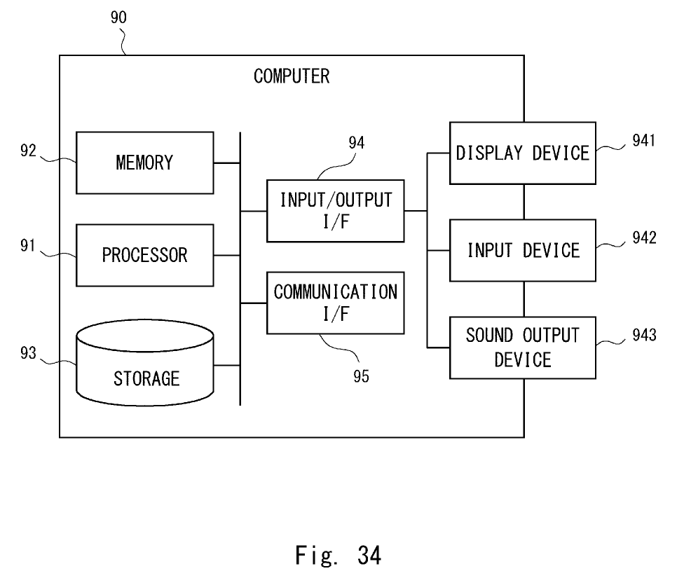

FIG. 34 is a block diagram illustrating a hardware configuration example of a computer 90 that implements some or all of the functions of the constituent elements included in the maintenance and operation systems 1 to 5 according to the present disclosure.

As illustrated in FIG. 34, the computer 90 includes a processor 91, a memory 92, a storage 93, an input/output interface (input/output I/F) 94, and a communication interface (communication I/F) 95. The processor 91, the memory 92, the storage 93, the input/output interface 94, and the communication interface 95 are connected via a data transmission path for mutually transmitting and receiving data.

The processor 91 is, for example, an arithmetic processing device such as a central processing unit (CPU) or a graphics processing unit (GPU). The memory 92 is, for example, a memory such as a random access memory (RAM) or a read only memory (ROM). The storage 93 is, for example, a storage device such as a hard disk drive (HDD), a solid state drive (SSD), or a memory card. The storage 93 may be a memory such as the RAM or the ROM.

A program is stored in the storage 93. This program includes a command group (or software codes) for causing the computer 90 to perform some or all of the functions of the constituent elements included in each of the maintenance and operation systems 1 to 5 in a case where the program is read by the computer. Some or all of the functions of the constituent elements included in each of the maintenance and operation systems 1 to 5 may be implemented by the processor 91 reading and executing a program stored in the storage 93. The storage function in each constituent element included in the maintenance and operation systems 1 to 5 may be achieved by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, and the like. The display device 941 is a device that displays a screen associated with drawing data processed by the processor 91, such as a liquid crystal display (LCD), a cathode ray tube (CRT) display, or a monitor. The input device 942 is a device that receives an operation input by an operator and is, for example, a keyboard, a mouse, a touch sensor, or the like. The display device 941 and the input device 942 may be integrated and achieved as a touch panel. The sound output device 943 is a device that acoustically outputs a sound relevant to acoustic data processed by the processor 91, such as a speaker.

The communication interface 95 transmits or receives data to and from an external device. For example, the communication interface 95 communicates with the external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

A maintenance and operation system including:

a generation device configured to receive an input of work information including a type of maintenance and operation work and a work parameter necessary for the maintenance and operation work, and generate a control instruction including commands to be input to a control target network device and information regarding an input order of the commands based on the work information;

a storage device configured to store the control instruction; and

an input device configured to input the commands to the control target network device in the input order of the commands based on the control instruction.

### Supplementary Note 2

The maintenance and operation system according to Supplementary Note 1, further including a smart device, wherein

the storage device is a server on the Internet, and

the input device is a control adapter connected to the smart device in a wireless or wired manner and connected to the control target network device in a wired manner.

### Supplementary Note 3

The maintenance and operation system according to Supplementary Note 1, further including a smart device,

wherein the storage device and the input device are control adapters connected to the smart device in a wireless or wired manner and connected to the control target network device in a wired manner.

### Supplementary Note 4

The maintenance and operation system according to Supplementary Note 1, wherein

the storage device is a server on the Internet, and

the input device is a smart device connected to the control target network device in a wired manner.

### Supplementary Note 5

The maintenance and operation system according to Supplementary Note 1, wherein the storage device and the input device are smart devices connected to the control target network device in a wired manner.

### Supplementary Note 6

The maintenance and operation system according to Supplementary Note 2, wherein

the generation device further generates a web page for downloading the control instruction,

the server further stores the web page,

the smart device accesses the server on the Internet using a wireless connection function to display the web page on a screen,

if a specific button in the web page displayed on the screen of the smart device is pressed, the server transfers the control instruction to the control adapter via the smart device, and

the control adapter inputs the commands to the control target network device in the input order of the commands based on the control instruction.

### Supplementary Note 7

The maintenance and operation system according to Supplementary Note 3, wherein

the generation device further generates a web page for executing the control instruction,

the control adapter further stores the web page,

the smart device accesses the control adapter using a wireless connection function to display the web page on a screen, and

if a specific button in the web page displayed on the screen of the smart device is pressed, the control adapter inputs the commands to the control target network device in the input order of the commands based on the control instruction.

### Supplementary Note 8

The maintenance and operation system according to Supplementary Note 4, wherein

the generation device further generates a web page for downloading the control instruction,

the server further stores the web page,

the smart device accesses the server on the Internet using a wireless connection function to display the web page on a screen,

the server transfers the control instruction to the smart device if a specific button in the web page displayed on the screen of the smart device is pressed, and

the smart device inputs the commands to the control target network device in the input order of the commands based on the control instruction.

### Supplementary Note 9

The maintenance and operation system according to Supplementary Note 6 or 8, wherein

the generation device further generates a two-dimensional code obtained by encoding a uniform resource locator (URL) for accessing the web page, and

the smart device displays the URL if the two-dimensional code is read using a camera function, and accesses the server on the Internet using the wireless connection function and displays the web page on the screen if the URL is touched.

### Supplementary Note 10

The maintenance and operation system according to Supplementary Note 7, wherein

the generation device further generates a two-dimensional code obtained by encoding a uniform resource locator (URL) for accessing the web page, and

the smart device displays the URL on the screen if the two-dimensional code is read using a camera function, and accesses the control adapter by using the wireless connection function and displays the web page on the screen if the URL is touched.

### Supplementary Note 11

The maintenance and operation system according to Supplementary Note 5, wherein

the generation device further generates a two-dimensional code for activating an application necessary for executing the control instruction, and

the smart device activates the application if the two-dimensional code is read using a camera function, and inputs the commands to the control target network device in the input order of the commands based on the control instruction if a specific button on a screen of the application is pressed.

### Supplementary Note 12

The maintenance and operation system according to Supplementary Note 2 or 3, wherein the control adapter is portable.

### Supplementary Note 13

The maintenance and operation system according to any one of Supplementary Notes 9 to 11, wherein the two-dimensional code is attached to a work implementation procedure manual defining a procedure of the maintenance and operation work.

### Supplementary Note 14

The maintenance and operation system according to Supplementary Note 13, wherein

the work implementation procedure manual is paper, and

the two-dimensional code is attached to the work implementation procedure manual as a printed matter.

### Supplementary Note 15

The maintenance and operation system according to Supplementary Note 13, wherein

the work implementation procedure manual is an electronic file, and

the two-dimensional code is attached to the work implementation procedure manual as an electronic image.

### Supplementary Note 16

A maintenance and operation method executed by a maintenance and operation system, the method including:

receiving an input of work information including a type of maintenance and operation work and a work parameter necessary for the maintenance and operation work;

generating a control instruction including commands to be input to a control target network device and information regarding an input order of the commands based on the work information;

storing the control instruction in a storage device; and

inputting the commands to the control target network device in the input order of the commands based on the control instruction.

Note that, some or all of elements (e.g., structures and functions) specified in Supplementary Notes 2 to 15 dependent on Supplementary Note 1 may also be dependent on Supplementary Note 16 in dependency similar to that of Supplementary Notes 2 to 15 dependent on Supplementary Note 1. Some or all of elements specified in any of Supplementary Notes may be applied to various types of hardware, software, and recording means for recording software, systems, and methods.

The present disclosure is applicable to all NW devices (for example, an optical transmission device, a switch, a router, a modem, or the like) connected to the NW and forming the NW infrastructure. The present disclosure is applicable not only to an NW device installed indoors but also to an NW device installed outdoors.

The present disclosure can be used in a case where an NW device is maintained and operated by a general company that provides NW communication, including a communication carrier. The present disclosure can be used in a case where an NW device is maintained and operated in a business entity, a corporation, or the like having a unique NW such as an in-house NW, an in-school NW, an academic NW, or a research NW.

What is claimed is:

1. A maintenance and operation system comprising:
a generation device configured to receive an input of work information including a type of maintenance and operation work and a work parameter necessary for the maintenance and operation work, and generate a control instruction including commands to be input to a control target network device and information regarding an input order of the commands based on the work information;
a storage device configured to store the control instruction; and
an input device configured to input the commands to the control target network device in the input order of the commands based on the control instruction.

2. The maintenance and operation system according to claim 1, further comprising a smart device, wherein
the storage device is a server on the Internet, and
the input device is a control adapter connected to the smart device in a wireless or wired manner and connected to the control target network device in a wired manner.

3. The maintenance and operation system according to claim 1, further comprising a smart device,
wherein the storage device and the input device are components provided in a control adapter connected to the smart device in a wireless or wired manner and connected to the control target network device in a wired manner.

4. The maintenance and operation system according to claim 1, wherein
the storage device is a server on the Internet, and
the input device is a smart device connected to the control target network device in a wired manner.

5. The maintenance and operation system according to claim 1, wherein the storage device and the input device are components provided in a smart device connected to the control target network device in a wired manner.

6. The maintenance and operation system according to claim 2, wherein
the generation device further generates a web page for downloading the control instruction,
the server further stores the web page,
the smart device accesses the server on the Internet using a wireless connection function to display the web page on a screen,
if a specific button in the web page displayed on the screen of the smart device is pressed, the server transfers the control instruction to the control adapter via the smart device, and
the control adapter inputs the commands to the control target network device in the input order of the commands based on the control instruction.

7. The maintenance and operation system according to claim 3, wherein
the generation device further generates a web page for executing the control instruction,
the control adapter further stores the web page,
the smart device accesses the control adapter using a wireless connection function to display the web page on a screen, and
if a specific button in the web page displayed on the screen of the smart device is pressed, the control adapter inputs the commands to the control target network device in the input order of the commands based on the control instruction.

8. The maintenance and operation system according to claim 4, wherein
the generation device further generates a web page for downloading the control instruction,
the server further stores the web page,
the smart device accesses the server on the Internet using a wireless connection function to display the web page on a screen,
if a specific button in the web page displayed on the screen of the smart device is pressed, the server transfers the control instruction to the smart device, and
the smart device inputs the commands to the control target network device in the input order of the commands based on the control instruction.

9. The maintenance and operation system according to claim 6, wherein
the generation device further generates a two-dimensional code obtained by encoding a uniform resource locator (URL) for accessing the web page, and
the smart device displays the URL if the two-dimensional code is read using a camera function, and accesses the server on the Internet using the wireless connection function and displays the web page on the screen if the URL is touched.

10. The maintenance and operation system according to claim 7, wherein
the generation device further generates a two-dimensional code obtained by encoding a uniform resource locator (URL) for accessing the web page, and
the smart device displays the URL on the screen if the two-dimensional code is read using a camera function, and accesses the control adapter by using the wireless connection function and displays the web page on the screen if the URL is touched.

11. The maintenance and operation system according to claim 5, wherein
the generation device further generates a two-dimensional code for activating an application necessary for executing the control instruction,
the smart device activates the application if the two-dimensional code is read using a camera function, and inputs the commands to the control target network device in the input order of the commands based on the control instruction if a specific button on a screen of the application is pressed.

12. The maintenance and operation system according to claim 2, wherein the control adapter is portable.

13. The maintenance and operation system according to claim 9, wherein the two-dimensional code is attached to a work implementation procedure manual defining a procedure of the maintenance and operation work.

14. The maintenance and operation system according to claim 13, wherein
the work implementation procedure manual is paper, and
the two-dimensional code is attached to the work implementation procedure manual as a printed matter.

15. The maintenance and operation system according to claim 13, wherein
the work implementation procedure manual is an electronic file, and
the two-dimensional code is attached to the work implementation procedure manual as an electronic image.

16. A maintenance and operation method executed by a maintenance and operation system, the method comprising:
receiving an input of work information including a type of maintenance and operation work and a work parameter necessary for the maintenance and operation work;
generating a control instruction including commands to be input to a control target network device and information regarding an input order of the commands based on the work information;
storing the control instruction in a storage device; and
inputting the commands to the control target network device in the input order of the commands based on the control instruction.
